(19) United States
(12) Patent Application Publication
(10) Pub. No.: US 2014/0152171 A1
(43) Pub. Date: Jun. 5, 2014

(54) DISPLAY PANEL AND METHOD FOR MANUFACTURING SAME

(71) Applicant: Tetsuro Kondoh, Hyogo (JP)

(72) Inventor: Tetsuro Kondoh, Hyogo (JP)

(73) Assignee: PANASONIC CORPORATION, Osaka (JP)

(21) Appl. No.: 14/233,163

(22) PCT Filed: Sep. 29, 2011
(86) PCT No.: PCT/JP2011/005523

§ 371 Date: Jan. 16, 2014

(51) Int. Cl. H05B 33/12; H05B 33/10

(52) U.S. Cl. CPC H05B 33/12; H05B 33/10
USPC 313/498; 445/24

(57) ABSTRACT

A display panel displays images by feeding an electric power individually to each of a plurality of display elements that are two-dimensionally arranged. The plurality of display elements are provided indirectly on a surface of a substrate with an insulating film between the plurality of display elements and the substrate, and the insulating film has one opening in a part thereof corresponding to each at least two of the plurality of display elements that are adjacent to each other. Feed terminals corresponding one-to-one to the at least two display elements are provided on a part of the substrate that is exposed inside the opening so as to share the opening, and the at least two display elements are electrically connected with the respective feed terminals provided in the opening.

### TECHNICAL FIELD

The present invention relates to a display panel and a method of manufacturing the display panel.

### BACKGROUND ART

In recent years, there has been considered a display panel having the structure in which light emitting elements that each include an organic light emitting layer between an anode (pixel electrode) and a cathode (common electrode) are formed in matrix indirectly on a substrate with an insulating film between the light emitting elements and the substrate (for example, Patent Literature 1).

FIG. 20 is a partial plan view showing an organic display panel using conventional organic light emitting elements. FIG. 21A, FIG. 21B, and FIG. 21C show an X1 -X2 cross section, a Y1 -Y2 cross section, and a Z1-Z2 cross section of the organic display panel in FIG. 20 viewed in an arrow direction, respectively.

The organic display panel includes a TFT substrate 905 on which TFT elements (drive terminals) 903 that are drive elements are provided in matrix. An insulating film 907 is formed on an upper surface of the TFT substrate 905.

A plurality of light emitting elements 909 are formed on an upper surface of the insulating film 907 with a predetermined pattern. The light emitting elements 909 each include an anode 911 that is formed on the insulating film 907, a light emitting layer 917 that is formed on the anode 911, and a cathode 919 that is formed on the light emitting layer 917. The light emitting elements 909 are partitioned by a bank 915 that is formed in the insulating film 907.

As shown in FIG. 20, FIG. 21B, and FIG. 21C, the anode 911 is connected with the TFT element 903 by providing an opening in the insulating film 907 so as to correspond in position to the TFT element 903 and forming the anode 911 above the TFT element 903 that is exposed inside the opening 921. The opening is a so-called contact window, and accordingly is hereinafter referred to as contact window. Note that the contact window 921 is filled with the same material as the bank 915 as shown in FIG. 21B and FIG. 21C.

### CITATION LIST

### Patent Literature

[Patent Literature 1] Japanese Patent Application Publication No. 2009-122652

### SUMMARY OF INVENTION

### Technical Problem

There has been recently a demand for size reduction of display panels without reducing the display size. However, it is difficult for the above art and the art disclosed in Patent Literature 1 to increase an aperture ratio of a display panel in order to meet this demand for size reduction. Here, the aperture ratio is an area ratio of a region effective for display (hereinafter, referred to just as display effective region) to the entire region in one light emitting element.

The present invention aims to provide a display panel having an increased aperture ratio and a method of manufacturing the display panel.

### Solution to Problem

One aspect of the present invention provides a display panel that displays images by feeding an electric power individually to each of a plurality of display elements that are two-dimensionally arranged, wherein the plurality of display elements are provided indirectly on a surface of a substrate with an insulating film between the plurality of display elements and the substrate, the insulating film has one opening in a part thereof corresponding to each at least two of the plurality of display elements that are adjacent to each other, and feed terminals corresponding one-to-one to the at least two display elements are provided on a part of the substrate that is exposed inside the opening so as to share the opening.

One aspect of the present invention provides a method for manufacturing a display panel that displays images by feeding an electric power individually to each of a plurality of display elements that are two-dimensionally arranged, the method comprising: preparing a substrate including thereon a plurality of feed terminals corresponding one-to-one to the plurality of display elements; forming, on the substrate, an insulating film having one opening in a part thereof corresponding to each at least two of the plurality of feed terminals that are adjacent to each other; and forming, on the insulating film, at least two display elements that are to be connected one-to-one with the at least two feed terminals so as to be close to the opening.

### Advantageous Effects of Invention

According to the display panel that is one aspect of the present invention, feed terminals corresponding one-to-one to at least two display elements are provided on a part of a substrate that is exposed inside an opening so as to share the opening. Since one opening is shared among a plurality of display elements, a rate of size of the opening in each of the plurality of display elements is small. This increases the aperture ratio compared with a display panel having the structure in which one opening is provided for each display element.

According to the method of manufacturing a display panel that is one aspect of the present invention, one opening is formed in a part of an insulating film corresponding to each adjacent at least two feed terminals, and at least two display elements that are to be connected one-to-one with the at least two feed terminals are formed so as to be close to the opening. Accordingly, a rate of size of the opening in each of the two or more display elements is small. This increases the aperture ratio compared with a display panel having the structure in which one opening is provided for each display element

### BRIEF DESCRIPTION OF DRAWINGS

FIG. 1 shows the overall structure of a display device relating to Embodiment 1.

FIG. 2 is a plan view showing a display panel relating to Embodiment 1.

FIG. 3A, FIG. 3B, and FIG. 3C show an X1-X2 cross section, a Y1-Y2 cross section, and a Z1-Z2 cross section of the display panel relating to Embodiment 1 in FIG. 2 viewed in an arrow direction, respectively.

FIG. 4 is a cross-sectional perspective view showing a contact window of the display panel relating to Embodiment 1.

FIG. 5 describes part of a method for manufacturing the display panel relating to Embodiment 1.

FIG. 6 shows comparison in aperture ratio between Example 1 and Conventional Example 1.

FIG. 7 is a cross-sectional view showing a region including a contact window.

FIG. 8 is a cross-sectional view showing a region including a contact window of a display device having a conventional structure.

FIG. 9A is a plan view showing a display panel relating to Embodiment 2, and FIG. 9B is a cross-sectional perspective view showing a contact window of the display panel.

FIG. 10A shows a Y1-Y2 cross section of the display panel relating to Embodiment 2 in FIG. 9 viewed in an arrow direction, and FIG. 10B shows a Z1-Z2 cross section of the display panel in FIG. 9 viewed in an arrow direction.

FIG. 11 shows comparison in aperture ratio between Example 2 and Conventional Example 2.

FIG. 12A and FIG. 12B are schematic plan views respectively showing a display panel relating to Embodiment 3 and a display panel having a conventional structure that each include subpixels each having a hexagonal shape in plan view.

FIG. 13A and FIG. 13B are each a schematic plan view showing a display panel including subpixel sets that are each composed of two subpixels.

FIG. 14A to FIG. 14C are each a schematic plan view showing a display panel including subpixel sets that are each composed of three subpixels.

FIG. 15A to FIG. 15C describe the aperture ratio of the display panel shown in FIG. 14A, where FIG. 15A is a plan view showing the display panel, FIG. 15B shows a Y1-Y2 cross section of the display panel in FIG. 15A viewed in an arrow direction, and FIG. 15C shows a cross section of a display panel having a conventional structure that corresponds to the Y1-Y2 cross section in FIG. 15A.

FIG. 16A is a schematic plan view showing a display panel including subpixel sets that are each composed of six subpixels, FIG. 16B shows a Y1-Y2 cross section of the display panel in FIG. 16A viewed in an arrow direction, and FIG. 16C shows a Z1-Z2 cross section of the display panel in FIG. 16A viewed in an arrow direction.

FIG. 17 is a schematic plan view showing a display panel in which a subpixel set composed of four subpixels are combined with a subpixel set composed of two subpixels.

FIG. 18 is a schematic plan view showing a display panel having openings that each have a groove shape.

FIG. 19A and FIG. 19B are each a schematic view showing a display panel in which anodes corresponding one-to-one to two vertically adjacent subpixels, which are an upper subpixel and a lower subpixel, are each connected with a TFT element in an opening such that the anodes corresponding to the upper subpixels and the anodes corresponding to the lower supixels are alternated with each other in the horizontal direction.

FIG. 20 is a partial plan view showing an organic display panel using conventional organic light emitting elements.

FIG. 21A, FIG. 21B, and FIG. 21C show an X1-X2 cross section, a Y1-Y2 cross section, and a Z1-Z2 cross section of the organic display panel in FIG. 20 viewed in an arrow direction, respectively.

### DESCRIPTION OF EMBODIMENTS

### Outline of One Aspect of the Present Invention

One aspect of the present invention provides a display panel that displays images by feeding an electric power individually to each of a plurality of display elements that are two-dimensionally arranged, wherein the plurality of display elements are provided indirectly on a surface of a substrate with an insulating film between the plurality of display elements and the substrate, the insulating film has one opening in a part thereof corresponding to each at least two of the plurality of display elements that are adjacent to each other, and feed terminals corresponding one-to-one to the at least two display elements are provided on a part of the substrate that is exposed inside the opening so as to share the opening.

Also, the opening is provided in plural, the plurality of openings may be dispersed over the insulating film, and the plurality of display elements each may share one of the plurality of openings with at least another one of the plurality of display elements. Also, when viewed in plan, the part of the insulating film corresponding to the at least two display elements may be positioned inside a region surrounded by a perimeter of the at least two display elements. Also, the plurality of display elements may be arranged in a first direction and a second direction that intersects the first direction, and the feed terminals may be provided in at least one of the first direction and the second direction.

Also, when viewed in plan, the part of the insulating film corresponding to the at least two display elements may be positioned outside a region surrounded by a perimeter of the at least two display elements. Also, the openings each may have one of a pore shape and a groove shape. Also, the plurality of display elements each may include a pixel electrode having an electrode part provided on the insulating film, a coupling part extending from the electrode part into the opening shared by the display element, and a connecting part provided in the opening, pixel electrodes included in each adjacent two of the plurality of display elements may be provided in a first direction, two feed terminals corresponding one-to-one to the two display elements may be provided in a second direction perpendicular to the first direction, and the two pixel electrodes included in the adjacent two display elements may extend toward each other to reach inside the opening shared by the two display elements, such that respective connecting parts of the two pixel electrodes are connected with the two feed terminals.

Also, the plurality of display elements each may include a pixel electrode having an electrode part provided on the insulating film, a coupling part extending from the electrode part into the opening shared by the display element, and a connecting part provided in the opening, and a bank may be provided on the insulating film so as to have a plurality of apertures corresponding one-to-one to the plurality of pixel electrodes at equal intervals.

One aspect of the present invention provides a method for manufacturing a display panel that displays images by feeding an electric power individually to each of a plurality of display elements that are two-dimensionally arranged, the method comprising: preparing a substrate including thereon a plurality of feed terminals corresponding one-to-one to the plurality of display elements; forming, on the substrate, an insulating film having one opening in a part thereof corresponding to each at least two of the plurality of feed terminals that are adjacent to each other; and forming, on the insulating film, at least two display elements that are to be connected one-to-one with the at least two feed terminals so as to be close to the opening.

### EMBODIMENTS

The following describes an embodiment of a display panel and a method of manufacturing the display panel relating to the present invention, with reference to the drawings. Note that the materials, numerical values, shapes described in the embodiment are just preferable examples, and accordingly the present invention is not limited by the embodiment.

Also, the present invention may be appropriately modified without departing from the scope of the technical ideas of the present invention. Furthermore, the embodiments may be combined with other embodiments and modifications that are described later as long as consistency is maintained, and scale reduction of members shown in the drawings differ from the actual scale reduction.

### Display Device

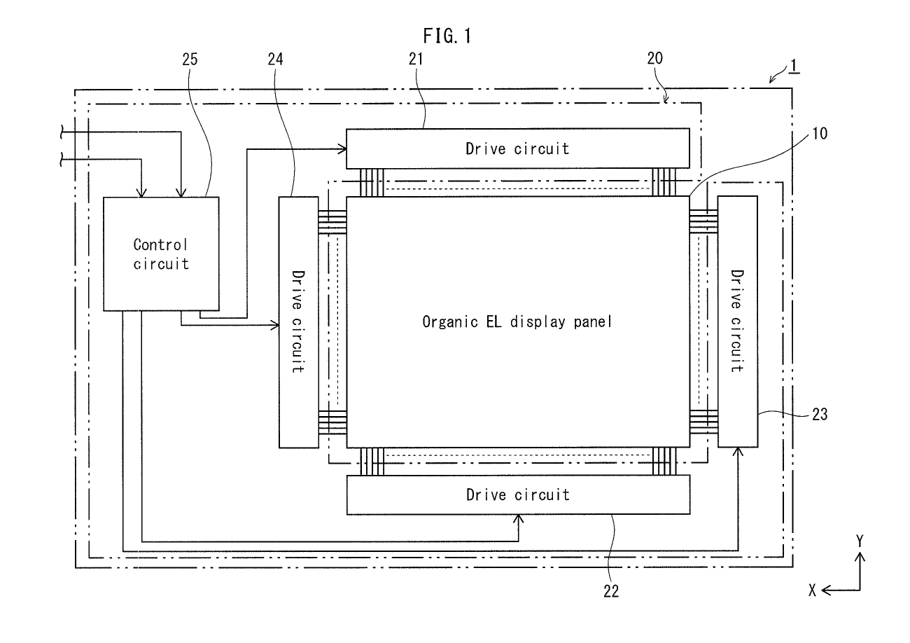

FIG. 1 shows the overall structure of a display device relating to Embodiment 1.

A display device 1 includes an organic EL display panel (hereinafter, referred to just as display panel) 10 including a plurality of organic light emitting elements that rely on electroluminescence phenomenon of organic materials (hereinafter, referred to just as light emitting elements) and a drive control unit 20 that is connected with the display panel 10 and controls driving of the organic light emitting elements. The display device 1 is used for a display, a TV, a mobile phone, and the like.

The display panel 10 includes the light emitting elements that are arranged above a substrate, for example in the XY directions (horizontal and vertical directions) in matrix. The drive control unit 20 includes four drive circuits 21 to 24 and a control circuit 25. Hereinafter, the horizontal and vertical directions of the display panel 10 are also referred to just as the horizontal direction and the vertical direction, or horizontally and vertically, respectively.

The display panel 10 here is an organic EL display panel. Alternatively, the display panel 10 may be an inorganic EL display panel using inorganic light emitting elements that rely on electroluminescence phenomenon of inorganic materials. Note that a display device including an organic EL display panel and a display device including an inorganic EL display panel are respectively referred to as an organic EL display device and an inorganic EL display device when it is necessary to distinguish therebetween.

Also, actual display devices are not limited by the arrangement and the connection between the display panel 10 and the drive control unit 20 described above.

### Embodiment 1

### 1. Outline of Display Panel

The following describes a display panel relating to Embodiment 1.

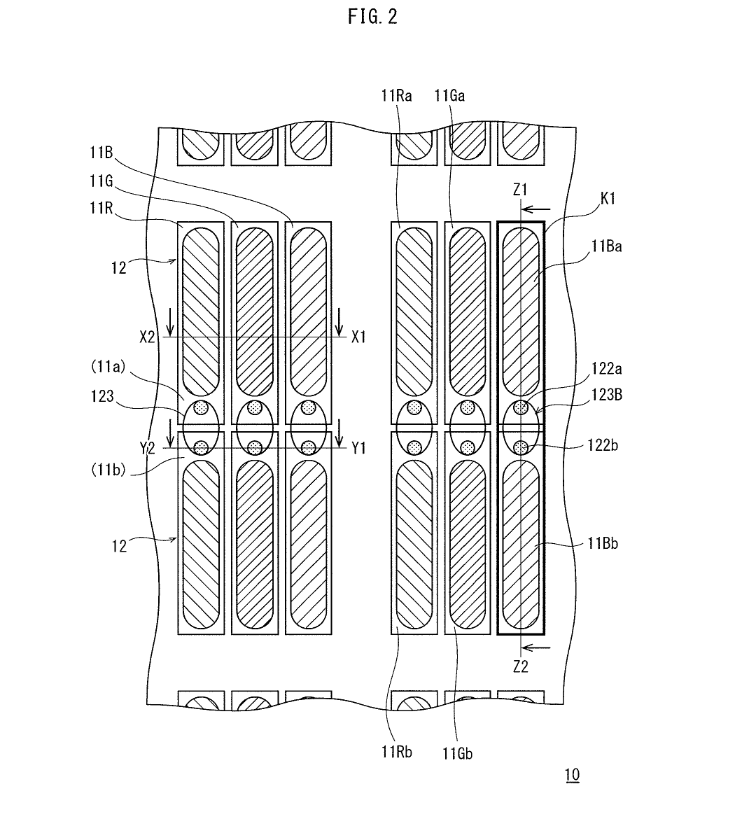

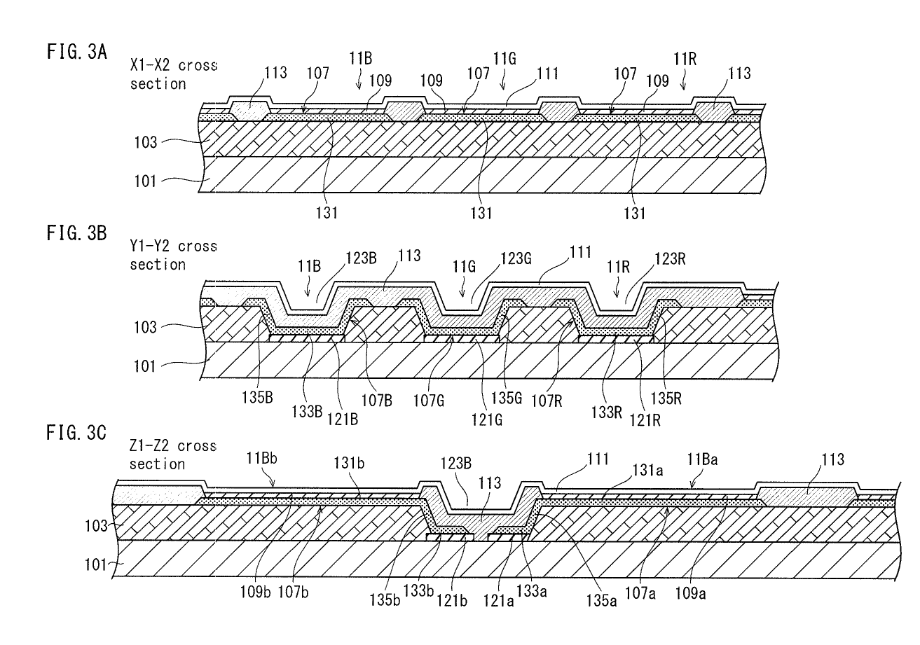

FIG. 2 is a plan view showing the display panel relating to Embodiment 1. FIG. 3A, FIG. 3B, and FIG. 3C show an X1-X2 cross section, a Y1-Y2 cross section, and a Z1-Z2 cross section of the display panel relating to Embodiment 1 in FIG. 2 viewed in an arrow direction, respectively.

The display panel 10 here is of a so-called top emission type. Specifically, the display panel 10 has a light emission direction toward the upper side in FIG. 3A to FIG. 3C, in other words, has a display surface toward the upper side in FIG. 3A to FIG. 3C.

The display panel 10 has the structure in which pixels 12 are each composed of three respective light emitting elements 11 that emit light of luminescent colors of red (R), green (G), and blue (B). The light emitting elements are hereinafter referred to as subpixels. The subpixels 11 are arranged in matrix. The subpixels correspond to display elements of the present invention.

Note that respective subpixels 11 that emit red light, green light, and blue light are expressed as subpixels 11R, 11G, and 11B. Also, when distinguishment by luminescent color is unnecessary, the simple expression subpixel 11 is used.

As shown in FIG. 2, the subpixels 11 are each a rectangle that is elongated in the vertical direction (Y direction in FIG. 1). Pixels 12 are each composed of three subpixels 11R, 11G, and 11B differing in luminescent color, and are each substantially a square in plan view.

The subpixels 11 are provided indirectly on a TFT substrate 101 with an insulating film 103 between the subpixels 11 and the TFT substrate 101 as shown in FIG. 3A and FIG. 3C. The subpixels 11 each include, as the basic structure, an anode 107 that is a pixel electrode formed on an upper surface of the insulating film 103 so as to correspond to the subpixel 11, a light emitting layer 109 that is formed on the anode 107, and a cathode 111 that is a common electrode formed on the light emitting layer 109. The subpixels 11 further each include a bank 113 that is provided mainly above the insulating film 103 for partitioning the subpixel 11 from one or more adjacent of the subpixels 11.

FIG. 2 is a pattern plan view showing the display panel 10 where rectangles each represent the subpixel 11, and rounded rectangles each represent the light emitting layer 109 that constitutes the subpixel 11.

When it is necessary to distinguish by luminescent color between the anodes 107 and between the light emitting layers 109, which constitute the subpixels 11R, 11G, and 11B, alphabets R, G, and B corresponding to respective luminescent colors are appended to the reference signs of the anodes 107 and the light emitting layers 109.

The TFT substrate 101 has, at each of a plurality positions, a TFT element set that is composed of two or more TFT elements 121. The TFT element set here is composed of two TFT elements 121 that are adjacent to each other in the vertical direction. While the upper TFT element 121 is referred to as TFT element 121a, the lower TFT element 121 is referred to as TFT element 121b.

The insulating film 103 has a contact window 123 that is an opening resulting from removing part of the insulating film 103 positioned above each of the TFT element sets. The TFT elements 121a and 121b are exposed on a bottom of the opening 123 so as to share the contact window 123.

The TFT elements 121a and 121b, which are exposed inside the contact window 123, are respectively connected with subpixels 11a and 11b shown in FIG. 2 which are respectively located above and below the contact window 123 in the vertical direction.

In FIG. 2, a contact window 123 is represented by an ellipse. Also, a connection part between the anode 107a and the TFT element 121a in the contact window 123 is represented by an upper circle 122a in the ellipse, and a connection part between the anode 107b and the TFT element 121 b in the contact window 123 is represented by a lower circle 122b in the ellipse.

Note that the subpixels 11a and 11b, which are vertically adjacent to each other with the contact window 123 therebetween, are referred to collectively as subpixel set.

When it is necessary to distinguish by luminescent color between the subpixels 11 which constitute each subpixel set, alphabets R, G, and B corresponding to respective luminescent colors are inserted between the number 11 and the alphabet a or b of the reference signs of the subpixels 11a and 11b which are vertically positioned one above the other. Similarly, when it is necessary to distinguish by luminescent color between the contact windows 123, alphabets R, G, and B corresponding to respective luminescent colors are appended to the reference signs of the contact window 123.

### 2. Structure of Components

### (1) Substrate

The TFT substrate 101 as a substrate for the display panel 10 is formed from an insulating material on which a plurality of TFT elements (TFTs) 121 are formed so as to drive the display panel 10 by the active matrix method. The anodes 107 are, for example, each connected with a source electrode (feed terminal) of a transistor that is a corresponding one of the TFT elements 121, and receives an electric power fed by the source electrode.

As shown in FIG. 2, FIG. 3B, and FIG. 3C, a TFT element set composed of two TFT elements 121 is provided in a region including each subpixel set, which is composed of two vertically adjacent subpixels 11. In FIG. 2, a perimeter that surrounds each region including one subpixel set is represented by a line segment K1. The perimeter collectively surrounds the subpixels that constitute the subpixel set.

With respect to vertically two adjacent subpixels 11Ba and 11Bb, as shown in FIG. 2 and FIG. 3C, the TFT element 121a corresponding to the upper subpixel 11Ba is positioned at the end (lower end) thereof close to the lower subpixel 11Bb, and the TFT element 121b corresponding to the lower subpixel 11Bb is positioned at the end (upper end) thereof close to the upper subpixel 11Ba.

### (2) Insulating Film

The insulating film 103 ensures insulating properties of the TFT elements 121, which are provided on the surface of the TFT substrate 101, and is provided for filling up (removing) concavity and convexity resulting from providing the TFT elements 121 and so on. The insulating film 103 is formed from an insulating material. The insulating film 103 has formed therein the contact windows 123 such that TFT elements 121a and 121b, which constitute each TFT element set, are exposed inside a corresponding one of the contact windows 123.

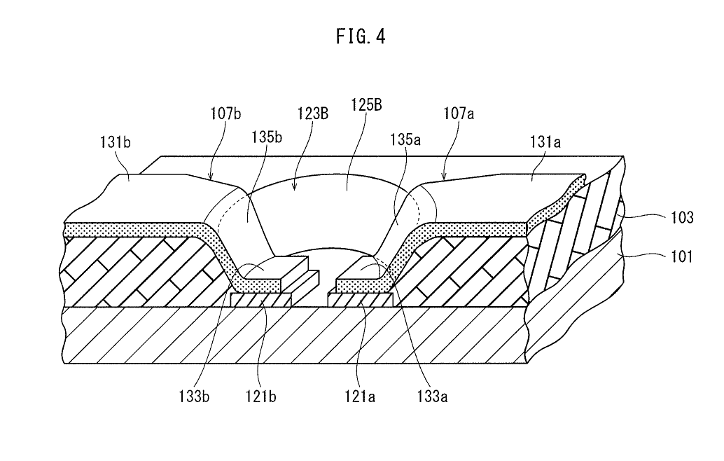

FIG. 4 is a cross-sectional perspective view showing a contact window of the display panel relating to Embodiment 1.

The contact windows 123 are each formed so as to extend over (straddle) a formation region of a subpixel set which is composed of vertically adjacent subpixels 11a and 11b.

The contact window 123 has an elliptical shape that is vertically elongated as shown in FIG. 2. The contact window 123 has an opening diameter that increases as the distance from the TFT elements 121 increases in the thickness direction, as shown in FIG. 3B and FIG. 3C. In other words, the contact window 123 is an elliptical frustum whose diameter decreases from the upper surface of the insulating film 103 toward the TFT substrate 101. As a result, the contact window 123 has an inclined circumferential surface 125 such that the opening diameter of the contact window 123 increases outward from the TFT elements 121 toward the upper surface of the insulating film 103.

### (3) Anode

The anodes 107 are for applying an electric field to the light emitting layer 109. The anodes 107 each have a vertically elongated shape in accordance with the shape of the subpixels 11 in plan view, and specifically have a rectangle shape. The anode 107 is formed in the insulating film 103 for each sub pixel 11 so as to be separated from adjacent of the anodes 107.

Description is given on the anode 107 with use of the anodes 107a and 107b, which respectively correspond to the subpixels 11Ba and 11Bb shown in FIG. 2.

The anodes 107a and 107b are respectively connected with the TFT elements 121a and 121b that are exposed inside the contact window 123B, which is formed so as to extend over the formation region of the subpixel set composed of the subpixels 11Ba and 11Bb.

As shown in FIG. 3B, FIG. 3C, and FIG. 4, the anodes 107a and 107b respectively include electrode parts 131a and 131b positioned on the upper surface of the insulating film 103, connecting parts 133a and 133b that are respectively connected with the TFT elements 121a and 121b, and coupling parts 135a and 135b that respectively couple the electrode parts 131a and 131b with the connecting parts 133a and 133b respectively. The anodes 107a and 107b are formed from a conducting material.

As shown in FIG. 4, the coupling parts 135a and 135b are formed mainly on the circumferential surface 125B of the contact window 123B (strictly, the coupling parts 135a and 135b may be formed on the bottom surface of the contact window 123B). The coupling parts 135a and 135b respectively have widths that increase from the connecting parts 133a and 133b toward the electrode parts 131a and 131b. Also, the electrode parts 131a and 131b respectively have parts whose width increases as the distance from the coupling parts 135a and 135b vertically increases.

### (4) Light Emitting Layer

The light emitting layers 109 emit light of a desired color through recombination of carriers (holes and electrons). As shown in FIG. 3A and FIG. 3C, the light emitting layers 109 are formed on the electrode parts 131 of the anodes 107. In other words, the bank 113 for partitioning between adjacent subpixels 11 is formed above the insulating film 103, and the light emitting layers 109 are formed on parts on the anode 107 that are partitioned by the bank 113. Respective light emitting layers shown in FIG. 2 and so on that correspond to the subpixels 11Ba and 11Bb are represented as light emitting layers 109Ba and 109Bb.

### (5) Cathode

The cathode 111 is formed so as to cover part of a surface of the bank 113 (including an upper surface and a slant surface) that is not covered with the light emitting layers 109 and cover upper surfaces of the light emitting layers 109.

The cathode 111 is formed from a translucent conductive material because of the display panel 10 relating to the present embodiment is of the top emission type.

### (6) Bank

The bank 113 is formed so as to surround each of the subpixels 11. Specifically, the bank 113 is formed on the anode 107 excepting the electrode part 131 and in the contact window 123. In other words, the bank 113 is formed so as to cover the surface of insulating film 103 except the electrode part 131 of the anode 107 formed on the insulating film 103 (strictly, except a central region other than the periphery of the electrode part 131).

When viewed in plan, the bank 113 forms a lattice shape in which apertures are formed on the upper surface of the electrode part 131 of the anode 107. The light emitting layers 109 are formed in the apertures.

The bank 113 fills between the anodes 107 that are vertically or horizontally adjacent to each other (see FIG. 3A and FIG. 3C). A part of the bank 113 above the upper surface of the anode 107 has a trapezoidal cross section whose upper bottom is shorter than a lower bottom. The bank 113 also fills the inside of the contact windows 123. As shown in FIG. 3C, the bank 113 fills between the TFT elements 121a and 121b, between the anodes 107a and 107b, and between the connecting parts 133a and 133b. A part of the bank 113 above the upper surface of the anode 107 has a trapezoidal cross section whose upper bottom is shorter than a lower bottom.

### 3. Manufacturing Method

The display panel 10 is formed through the following processes: a substrate preparation process of preparing a substrate on which TFT element sets are provided; an insulating film formation process of forming an insulating film on the substrate so as to have a contact window corresponding in position to each of the TFT element sets; an anode formation process of forming an anode on the upper surface of the insulating film so as to reach each TFT element exposed inside a contact window; a bank formation process of forming a bank having an aperture on each anode formed above the upper surface of the insulating film; a light emitting layer formation process of forming a light emitting layer in the aperture of the bank; and a cathode formation process of forming a cathode on a surface of the bank and an upper surface of the light emitting layer.

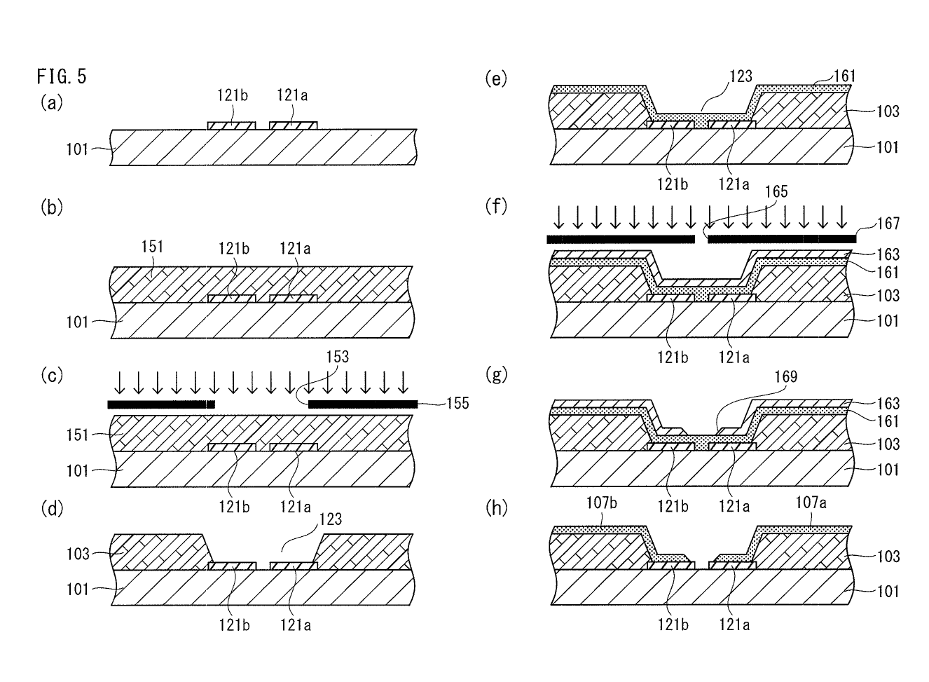

FIG. 5 describes part of a method for manufacturing the display panel relating to Embodiment 1.

The following describes the processes of the method with reference to FIG. 5.

### (1) Substrate Preparation Process

In the substrate preparation process, a substrate 101 is prepared. For example, a TFT substrate or an insulating plate may be prepared which has a TFT element set on each of predetermined positions of a surface thereof. TFT elements that constitute the TFT element set are provided so as to be close to each other.

The predetermined position where the TFT element set is formed is positioned where a contact window 123 is to be formed. TFT elements 121 a and 121b, which are to be exposed inside the contact window 123, are respectively to be connected with anodes 107a and 107b, which are to be formed so as to be adjacent to (correspond to) the contact window 123.

### (2) Insulating Film Formation Process

The insulating film formation process is composed of an insulating film formation subprocess (section (b) of FIG. 5) and an opening formation subprocess (sections (c) and (d) of FIG. 5). In the insulating film formation subprocess, an insulating film 151, which is formed from a material corresponding to an insulating film 103, is formed on an upper surface of the substrate 101. In the opening formation subprocess, an opening is formed in the insulating film 151 so as to correspond in position to each TFT element set composed of TFT elements 121a and 121b.

The insulating film 151 is obtained for example by applying an organic material film such as an acrylic resin and a polyimide resin onto the upper surface of the TFT substrate 101. The opening is obtained for example by using the photolithography method. Specifically, as shown in section (c) of FIG. 5, exposure and development are performed on the insulating film 151 with use of a photomask 155 having an opening 153 corresponding to the TFT elements 121a and 121b. As a result, as shown in section (d) of FIG. 5, an insulating film 103 having the contact window 123 is obtained.

### (3) Anode Formation Process

The anode formation process is for example composed of a conductive film formation subprocess of forming a conductive film 161 (section (e) of FIG. 5) and an unnecessary part removal subprocess (pattern forming subprocess) of removing an unnecessary part from the conductive film 161 (sections (f) to (h) of FIG. 5).

In FIG. 5, the unnecessary part of the conductive film 161 includes a part positioned in the contact window 123 except the upper surface of the TFT elements 121a and 121b, and a part (not illustrated) positioned between each two adjacent subpixels 11 for forming an anode 107 for each subpixel 11.

In the conductive film formation subprocess, the conductive film 161 is obtained on a surface of the insulating film 103 by using a vacuum deposition method such as the sputtering method and the vacuum evaporation method. Instead of the vacuum deposition method, the conductive film 161 may be obtained in atmosphere with use of a conductive ink or a conductive paste.

In the unnecessary part removal subprocess, the unnecessary part is removed by using the photolithography method. Specifically, as shown in section (f) of FIG. 5, a resist film 163 is applied onto the conductive film 161, exposure is performed on the applied resist film 163 with use of a mask 167 having an opening 165 corresponding to the unnecessary part. Next, the exposed resist film 163 is developed so as to have an opening 169 in a part corresponding to the unnecessary part as shown in section (g) of FIG. 5. Then, the unnecessary part is removed from the conductive film 161 by etching the conductive film 161. Finally, the resist film 163 is removed.

Through the above processes, the anodes 107a and 107b, which are respectively connected with the TFT elements 121a and 121b, are formed in the insulating film 103 as shown in section (h) of FIG. 5.

### (4) Bank Formation Process

A bank 113 is for example formed in the bank formation process that is composed of an organic material film formation subprocess and an unnecessary part removal subprocess (pattern forming subprocess). In the organic material film formation subprocess, an organic material film is formed by applying an organic material for bank. In the unnecessary part removal subprocess, a mask having apertures corresponding to the bank 113 is overlaid on the organic material film, exposure is performed on the organic material film through the mask, and then an unnecessary part of the organic material film is washed out with a developer. As a result, the bank 113 having apertures is formed so as to correspond to the electrode part 131 of the anode 107.

### (5) Light Emitting Layer Formation Process

A light emitting layer 109 is formed for example by using the inkjet method. Specifically, an ink including a solvent and an organic material corresponding to each of R, G, and B colors is dropped in the opening of the bank 113 (dropping subprocess), and the solvent is evaporated to be dried (drying subprocess).

### (6) Cathode Formation Process

The cathode 111 is formed for example by using a vacuum deposition method such as the sputtering method and the vacuum evaporation method.

### 4. Examples

### (1) Substrate

The TFT substrate 101 is formed from an insulating material such as a non-alkali glass, a soda glass, a nonfluorescent glass, a phosphate glass, a borate glass, a quartz, an acrylic resin, a styrenic resin, a polycarbonate resin, an epoxy resin, a polyethylene, a polyester, a silicone resin, and an alumina.

The TFT elements 121, which are formed on the surface of the TFT substrate 101, are formed from, as a channel material, a silicon, an oxide material semiconductor such as an indium gallium zinc oxide, an organic semiconductor such as a pentacene, or the like.

### (2) Insulating Film

The insulating film 103 is formed from an insulating material such as a polyimide resin and an acrylic resin. The insulating film 103 has a thickness depending on a degree of unevenness on the surface of the TFT substrate 101. The insulating film 103 for example should have a thickness five times a height or depth of the unevenness or more, namely 1000 nm or more. In the case where a subpixel is formed so as to correspond to a flat part of the unevenness on the surface of the TFT substrate 101 (for example, a flat part on a bottom of a concavity), the insulating film 103 may have a thickness which is less than five times the height or depth of the unevenness, namely less than 1000 nm.

### (3) Anode

The anode 107 is formed from a conductive material such as APC (alloy of silver, palladium, and copper), ARA (alloy of silver, rubidium, and gold), MoCr (alloy of molybdenum and chromium), and NiCr (alloy of nickel and chromium).

### (4) Light Emitting Layer

The light emitting layer 109 is formed from polyparaphenylene vinylene (PPV) or polyfluorene. Also, the light emitting layer 109 is formed from a fluorescent material disclosed in Japanese Patent Application Publication No. H5-163488 such as an oxinoid compound, a perylene compound, a coumarin compound, an azacoumarin compound, an oxazole compound, an oxadiazole compound, a perinone compound, a pyrrolo-pyrrole compound, a naphthalene compound, an anthracene compound, a fluorene compound, a fluoranthene compound, a tetracene compound, a pyrene compound, a coronene compound, a quinolone compound and an azaquinolone compound, a pyrazoline derivative and a pyrazolone derivative, a rhodamine compound, a chrysene compound, a phenanthrene compound, a cyclopentadiene compound, a stilbene compound, a diphenylquinone compound, a styryl compound, a butadiene compound, a dicyanomethylene pyran compound, a dicyanomethylene thiopyran compound, a fluorescein compound, a pyrylium compound, a thiapyrylium compound, a selenapyrylium compound, a telluropyrylium compound, an aromatic aldadiene compound, an oligophenylene compound, a thioxanthene compound, a cyanine compound, an acridine compound, a metal complex of a 8-hydroxyquinoline compound, a metal complex of a 2-bipyridine compound, a complex of a Schiff base and a group three metal, a metal complex of an oxine, and a rare earth metal complex.

### (5) Cathode

The cathode 111 is formed from a translucent material such as ITO and IZO.

### (6) Bank

The bank 113 has a trapezoidal aperture on the anode 107 whose aperture width decreases as the distance from the anode 107 decreases on a cross section thereof. In other words, a bank width of the bank 113 increases as the distance from the anode 107 decreases on the cross section. The bank 113 is formed from an insulating organic material such as an acrylic resin, a polyimide resin, and a novolac-type phenolic resin, or an inorganic material such as SiO2 and SiON.

### 5. Aperture Ratio

### (1) Outline

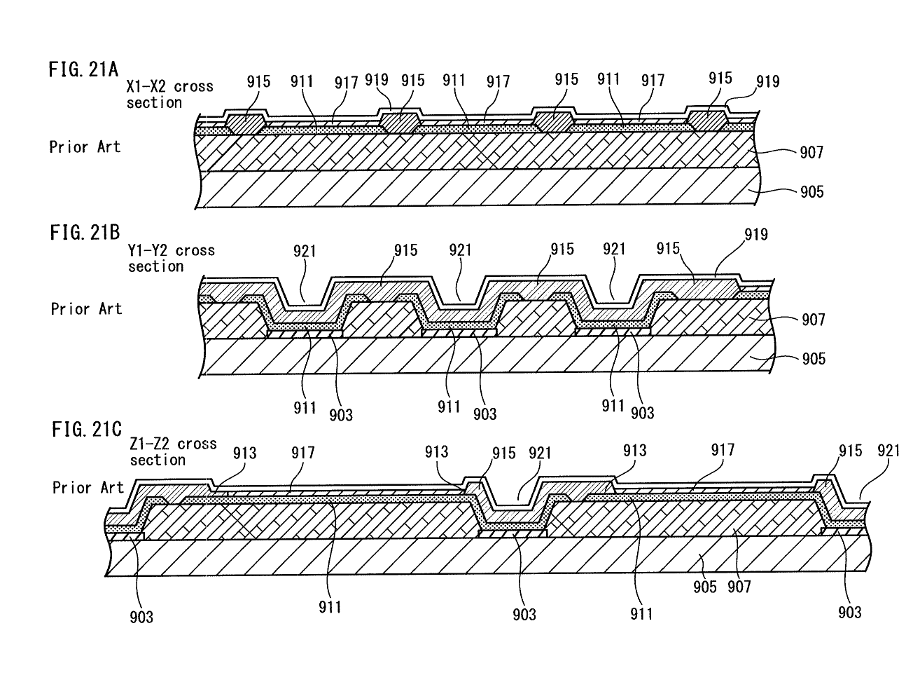

Description is given on the aperture ratio of the display panel 10 relating to Embodiment 1, based on comparison with an aperture ratio of a display panel having a conventional structure (see FIG. 20 and FIG. 21 for example). The display panel relating to Embodiment 1 is referred to as Example 1, and the display panel having the conventional structure is referred to as Conventional Example 1.

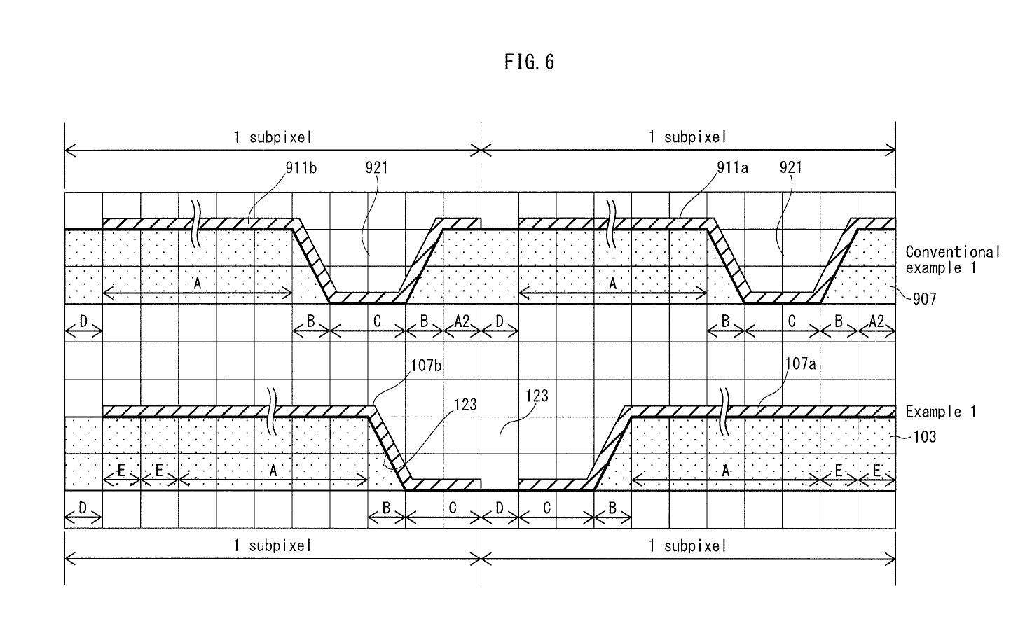

FIG. 6 shows comparison in aperture ratio between Example 1 and Conventional Example 1.

FIG. 6 schematically shows anodes 107a and 107b corresponding to respective subpixels that are vertically adjacent to each other in Example 1, and anodes 911a and 911b corresponding to respective subpixels that are vertically adjacent to each other in Conventional Example 1.

In FIG. 6, signs A and A2 each represent a length of part of an anode formed on each of insulating films 103 and 907. Particularly, the sign A represents a length of an electrode part that is equal to a length of a display effective region. A sign B represents a taper length of a circumferential surface of each of contact windows 123 and 921 in the horizontal direction. A sign C represents a length of a connecting part. A sign D represents a length for ensuring insulating properties between adjacent anodes. Example 1 and Conventional Example 1 are equal to each other in terms of respective length represented by the signs A to D and the depth of contact window.

As shown in FIG. 6, each subpixel in Conventional Example 1 has a length equal to the sum of the length D+A+B+C+B+A2, which start from the left in FIG. 6. Compared with this, respective pixels in Example 1 on the left side and the right side respectively have a length equal to the sum of the length D+2E+A+B+C and a length equal to the sum of the length D+C+B+A+2E, which start from the left in FIG. 6 The respective subpixels on the left side and the right side in Example 1 have the same length. Also, the respective subpixels in Conventional Example 1 and Example 1 have the same length.

The above comparison demonstrates that Example 1 is longer in terms of display effective region for each subpixel than Conventional Example 1 by the length 2E. Therefore, it is possible to increase the aperture ratio in Example 1 by the length 2E compared with Conventional Example 1. The difference 2E is equal to the sum of the length B and A2 in Conventional Example 1.

### (2) Contact Window

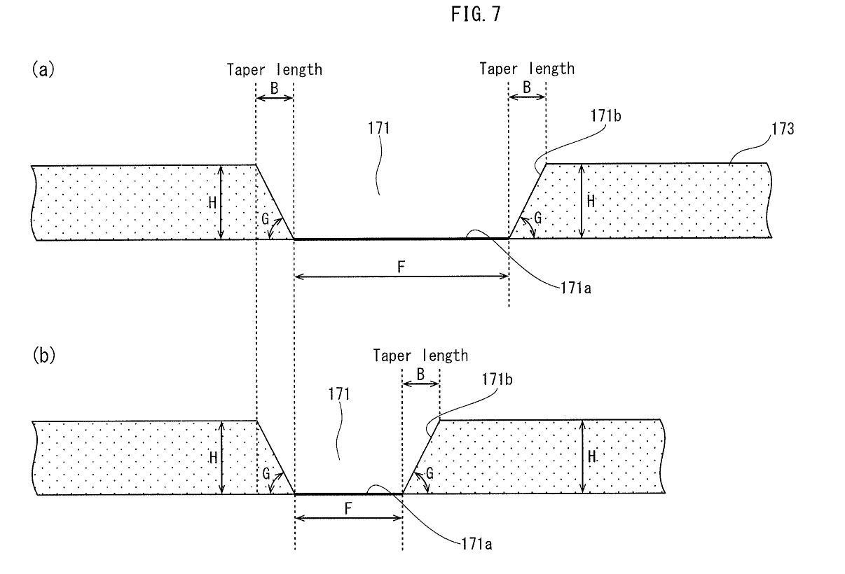

FIG. 7 is a cross-sectional view showing a region including a contact window.

As shown in section (a) of FIG. 7, a contact window 171 has a size equal to the sum of a length F of a bottom 171a of the contact window 171 and twice a taper length B that is a length of a circumferential surface 171b of the contact window 171.

Here, the circumferential surface 171b of the contact window 171 should preferably have an inclination angle G of 90 degrees or less, from the viewpoint of manufacturing the contact window 171. Also, the inclination angle G should preferably be particularly 70 degrees or less, in consideration of that a coupling part 135 of an anode 107 is formed on the circumferential surface 171b of the contact window 171. Under the conditions that the inclination angle G is fixed to a predetermined angle of 70 degrees or less as described above, the taper length B is determined by a thickness H of the insulating film 173.

The inclination angle G of 70 degrees or less enables efficient formation of the coupling part 135, thereby further improving the adhesive strength between the circumferential surface 171b of the contact window 171 and the anode 107.

On the other hand, the thickness of the light emitting layer 109 and so on is subject to an influence of an uneven foundation, in other words, uneven light emission is likely to be caused by uneven foundation. For this reason, there has recently been a tendency to increase the thickness of the insulating film 103, in order to form the light emitting layer 109 on a flat part and also in order to reduce a parasitic capacity between the anode 107 and a conductive layer of the TFT substrate 101 (elements except the TFT elements 121 and electrodes except the source electrodes of the TFT elements 121).

Therefore, although the size of the contact window 171 is reduced as shown in section (b) of FIG. 7 owing to the improvement in the art of forming the contact window 171, this only results in reduction of the length F of the bottom 171a of the contact window 171, and the taper length B cannot be reduced.

On the cross section of the contact window 171 in Example 1, the anodes 107a and 107b are formed with use of the two circumferential surfaces 171b. Therefore, it is possible to substantially reduce the taper length B of one of the circumferential surfaces 171b for each subpixel compared with Conventional Example 1, thereby increasing the aperture ratio.

### (3) Consideration

In Conventional Example 1 shown in FIG. 6, the length of one subpixel includes the length A2 and D. A part of the anode 911 having the length A2 is formed on the upper surface of the insulating film 907 so as to reach the contact window 921, in order to ensure the adhesive strength between the inner circumferential surface of the contact window 921 and the anode 911. However, since a bank 915 is formed on the anode 911 for example, the adhesion between the contact window 921 and the anode 907 does not often become a problem.

Accordingly, on the cross section of the contact window 921 in Conventional Example 1, the anode 911 may be formed on the bottom 171a and one of the circumferential surfaces 171b (see FIG. 7) in the same manner as Example 1, and it is unnecessary to form an anode on the other circumferential surface 171b (see FIG. 7). With this structure, the adjacent anodes 911a and 911b are separated from each other because of no anode being formed on the other circumferential surface 171b. As a result, in Conventional Example 1 shown in FIG. 6, it is unnecessary to provide the length A2 for ensuring the insulating properties between the adjacent anodes 911a and 911b.

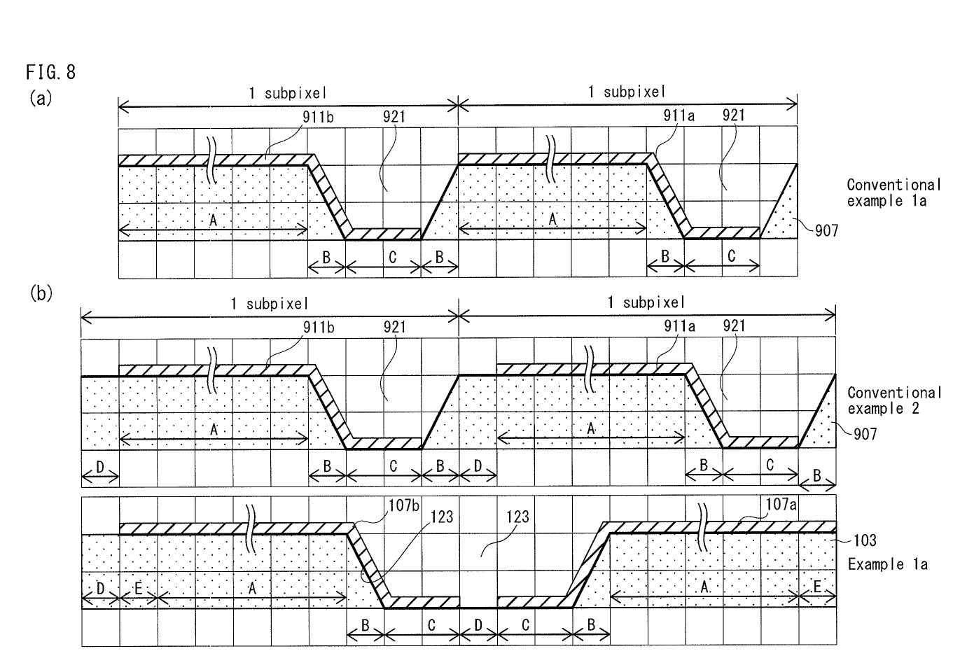

FIG. 8 is a cross-sectional view showing a region including a contact window of a display panel having a conventional structure.

Section (b) of FIG. 8 shows Example 1a that is equal to Conventional Example 2 in terms of length of subpixel.

Section (a) of FIG. 8 shows Comparative Example 1a that is equivalent to Comparative Example 1 from which parts having the length A2 and D are removed.

Each subpixel in Comparative Example 1a has a length equal to the sum of the length A+B+C+B, which start from the left in FIG. 8, and is equal to the length of each subpixel in Example 1 shown in FIG. 6.

In Comparative Example 1a, however, anodes 911a and 911b are each formed on an insulating film 907 and reaches a periphery of a contact window 921. Uneven light emission occurs around the periphery due to unevenness of the contact window 123.

Also, respective peripheries of the anodes 911a and 911b are each covered with a bank 915. One of edges of each of the anodes 911a and 911b, which does not extend in the contact window 921 (the left edge of each subpixel), reaches the periphery of the contact window 921. This makes it difficult to manage the bank 915 to cause variation in area of any of light emitting layers 917. As a result, uneven luminance occurs.

As described above, in the case where the structure is adopted in which one anode 911 is connected with for each contact window 921, it is possible to remove the parts having the length A2 and D from each subpixel in Conventional Example 1 shown in FIG. 6 in order to increase the aperture ratio. However, this removal results in deterioration of the display capability such as uneven light emission.

Compared with this, Conventional Example 2 shown in section (b) of FIG. 8 has the shortest length of each subpixel among display panels which have the same display capability equivalent to that of Example 1 and have the structure in which one anode 911 is connected with one TFT element 903 located in each contact window 921.

Each subpixel in Comparative Example 2 has a length equal to the sum of the length D+A+B+C+B, which start from the left in FIG. 8. Example 1a shown in section (b) of FIG. 8 is equivalent to Example 1 shown in FIG. 6 whose length for each subpixel is equalized to that in Conventional Example 2.

In Conventional Example 2, the length of each subpixel of the display panel described in Background Art is set longest, without deteriorating the display capability. Even in the case where Example 1 a has the length for each subpixel which is equal to that in Conventional Example 2, it is possible to increase the length of the display effective region of Example 1 a by the length E for each subpixel compared with Conventional Example 2.

The length E of the increased part of the effective display region in Example 1a is equal to the taper length B in Conventional Example 2. Also, there is a tendency that the thickness of the insulating films 103 and 907 increases as shown in FIG. 7. Furthermore, the inclination angle G cannot be increased. In consideration of these, it is important to increase the aperture ratio by increasing the length E (the taper length B) for each subpixel.

### (4) Specific Examples

(a) 20-inch HD Panel (High Definition)

A 20-inch HD panel has a taper length B of 10 μm and a length of each subpixel (anode part) of 300 μm, thereby increasing the aperture ratio by approximately 3%.

(b) 40-inch Panel (Resolution: 4 k×2 k)

A 40-inch panel has a taper length B of 1 μm and a length of each subpixel of 200 μm, thereby increasing the aperture ratio by approximately 0.5%.

### Embodiment 2

In Embodiment 1, the contact window 123 is located between the two subpixels 11a and 11b, which are adjacent to each other in the vertical direction. The TFT elements 121a and 121b are arranged inside the contact window 123 in the vertical direction which is the adjacent direction. However, the TFT elements 121 do not need to be arranged inside the contact window 123 in the adjacent direction of the subpixels 11a and 11b (two subpixels 11a and 11b here), and may be arranged in other pattern.

A display panel 210 relating to Embodiment 2 has the structure in which TFT elements 221a and 221b, which are respectively connected with two adjacent subpixels 211a and 211b, are arranged inside a contact window 223 in a direction perpendicular to the adjacent direction of the subpixels 211a and 211b.

### 1. Structure

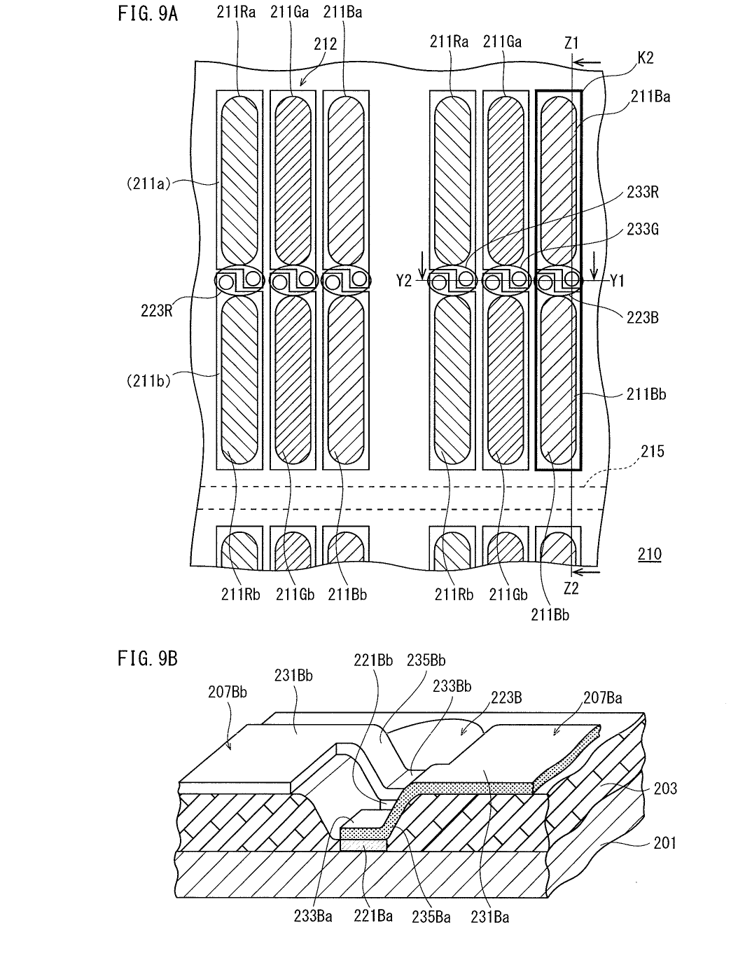

FIG. 9A is a plan view showing the display panel relating to Embodiment 2, and FIG. 9B is a cross-sectional perspective view showing a contact window of the display panel.

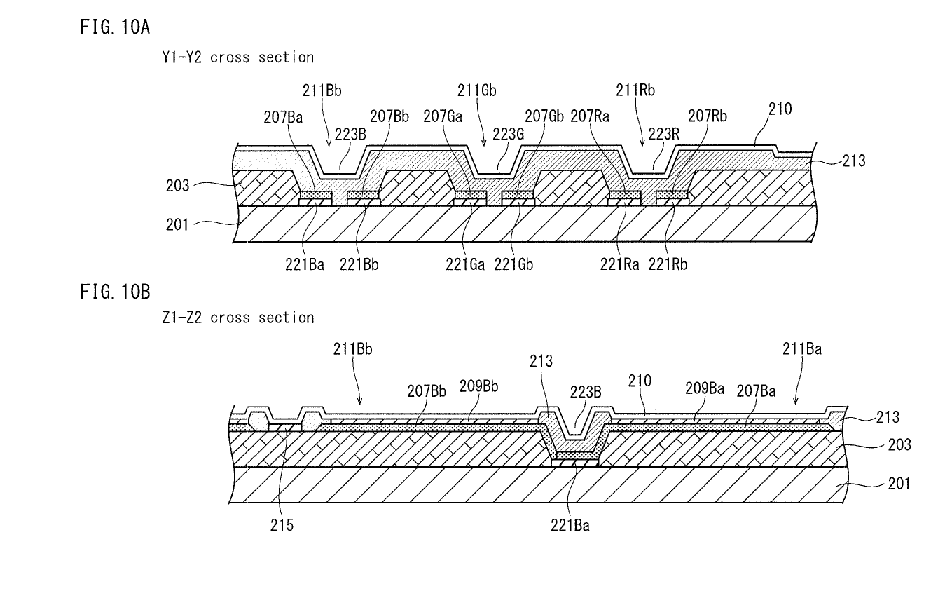

FIG. 10A shows a Y1-Y2 cross section of the display panel relating to Embodiment 2 in FIG. 9 viewed in an arrow direction, and FIG. 10B shows a Z1-Z2 cross section of the display panel in FIG. 9 viewed in an arrow direction.

The display panel 210 includes a plurality of pixels 212 that are arranged in the horizontal and vertical directions in matrix. The pixels 212 are each composed of respective three subpixels 211 corresponding to luminescent colors of R, G, and B.

When it is necessary to distinguish between the subpixels 211 by luminescent color, alphabets R, G, and B corresponding to respective luminescent colors are appended to the reference signs of the subpixels 211. The three subpixels 211R, 211G, and 211B are each a rectangle that is vertically elongated. The pixel 212, which is composed of the three subpixels 211R, 211G, and 211B, is substantially a square in plan view as shown in FIG. 9A.

The display panel 210 includes a TFT substrate 201, an insulating film 203, the subpixels 211 as shown in FIG. 10A and FIG. 10B. The subpixels 211 each have substantially the same structure as that in Embodiment 1, but has a different structure in which an anode extends to a TFT element from that in Embodiment 1.

Description is given here with use of two subpixels 211Ba and 211Bb, which are vertically adjacent to each other, as a representative example.

As shown in FIG. 10A and FIG. 10B, the subpixels 211Ba and 211Bb respectively have anodes 207Ba and 207Bb, which are respectively formed on an upper surface of the insulating film 203 so as to correspond to the subpixels 211Ba and 211Bb, light emitting layers 209Ba and 209Bb, which are respectively formed on the anodes 207Ba and 207Bb, and a cathode 210, which is formed on the light emitting layers 209Ba and 209Bb. The subpixels are each partitioned from each adjacent subpixel by a bank 213 formed on the insulating film 203.

The insulating film 203 has formed therein a contact window 223B resulting from removing part thereof above the TFT elements 221Ba and 221Bb. The contact window 223B is located in a region including a subpixel set composed of the subpixels 211Ba and 211Bb. In FIG. 9A, a perimeter that surrounds each region including one subpixel set is represented by a line segment K2.

The following description is given focusing on the contact window 223B shown in FIG. 9B. The TFT elements 221Ba and 221Bb, which are respectively connected with the adjacent subpixels 211Ba and 211Bb located around the contact window 223B, are exposed on a bottom of the contact window 223B.

The TFT elements 221Ba and 221Bb are arranged in the direction perpendicular to the adjacent direction of the subpixels 211Ba and 211Bb, which respectively correspond thereto. The TFT elements 221Ba and 221Bb are located in respective two regions in the contact window 223B that are divided by a virtual borderline extending in the adjacent direction of the subpixels 211Ba and 211Bb.

The anodes 207Ba and 207Bb, which respectively correspond to the subpixels 211Ba and 211Bb, are described focusing on the contact window 223B shown in FIG. 9B. The anodes 207Ba and 207Bb respectively include electrode parts 231Ba and 231Bb, connecting parts 233Ba and 233Bb, and coupling parts 235Ba and 235Bb similarly to in Embodiment 1.

The electrode parts 231Ba and 231Bb are formed on the insulating film 203, and are each a rectangle that is elongated in the vertical direction of the display panel 210. The contact window 223B is formed between the electrode parts 231Ba and 231Bb that are vertically adjacent to each other.

As shown in FIG. 9B, the coupling parts 235Ba and 235Bb respectively extend, on circumferential surfaces of the respective divided regions in the contact window 223B, from the electrode parts 231Ba and 231Bb to the connecting parts 233Ba and 233Bb along the longitudinal directions of the electrode parts 231Ba and 231Bb.

As shown in FIG. 9A and FIG. 10B, an auxiliary electrode 215 extends in the horizontal direction between each two subpixel sets that are vertically adjacent to each other. The auxiliary electrode 215 is for uniformizing the electrical properties of the cathode 210.

### 2. Aperture Ratio

Description is given on the aperture ratio of the display panel 210 relating to Embodiment 2, based on comparison with an aperture ratio of a display panel having a conventional structure (see section (b) of FIG. 8). The display panel relating to Embodiment 2 is referred to as Example 2, and the display panel having the conventional structure is referred to as Conventional Example 2.

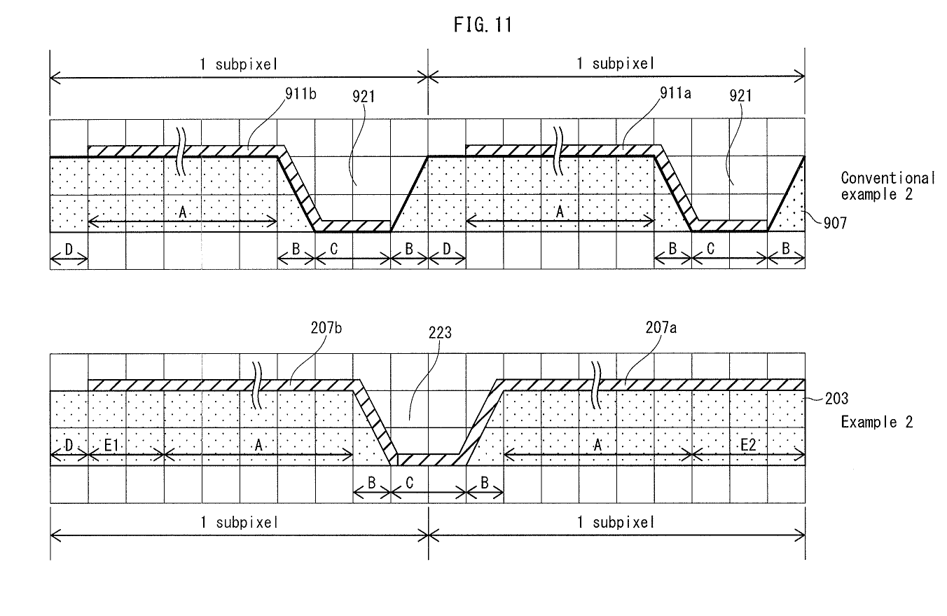

FIG. 11 shows comparison in aperture ratio between Example 2 and Conventional Example 2.

FIG. 11 is a schematic view showing anodes 911a and 911b and anodes 207a and 207b, which respectively correspond to vertically adjacent subpixels. Example 2 is equal to Conventional Example 2 in terms of length of subpixel.

In FIG. 11, respective length represented by signs A to D are defined in the same manner as those in Embodiment 1. Example 2 and Conventional Example 2 are equal to each other in terms of respective length represented by the signs A to D and the depth of contact window.

As shown in FIG. 11, two pixels in Conventional Example 2 have the entire length equal to the sum of the length D+A+B+C+B+D+A+B+C+B, which start from the left in FIG. 11. Compared with this, two pixels in Example 2 have the entire length equal to the sum of the length D+E1+A+B+C+B+A+E2, which start from the left in FIG. 11.

The above comparison demonstrates that Example 2 is longer than Conventional Example 2 in terms of length of display effective region for each two subpixels by the length E1+E2. The length E1+E2 is equal to a length B+C+B+D, namely, the sum of a length B+C+B of one contact window 921 in Conventional Example 2 and the length D.

In this way, in the case where Example 2 is equal to Conventional Example 2 in terms of length of each subpixel, Example 2 is longer than Conventional Example 2 in terms of length of display effective region. As a result, it is possible to increase the aperture ratio in Example 2 compared with Conventional Example 2.

### 3 Specific Examples

In the case where a 40-inch panel (resolution: 4 k×2 k) has formed therein contact windows 223 each having a bottom surface of 5 μm and an upper surface of 7 μm, it is possible to reduce the length of each two subpixels by at least a length of one contact window 921, in other words, reduce the length of each subpixel by 3.5 μm. It is possible to increase the aperture ratio of the 40-inch panel having pixels each having a length of 200 μm by approximately 1.75% compared with Conventional Example 2.

### Embodiment 3

In Embodiments 1 and 2, the subpixels are each a rectangle in plan view. Alternatively, the subpixel may have other shape in plan view such as a square, a circle, and an ellipse, or a polygon such as a hexagon. The following describes a display panel 301 relating to Embodiment 3 that includes subpixels (light emitting elements) 311 that are each a hexagon in plan view.

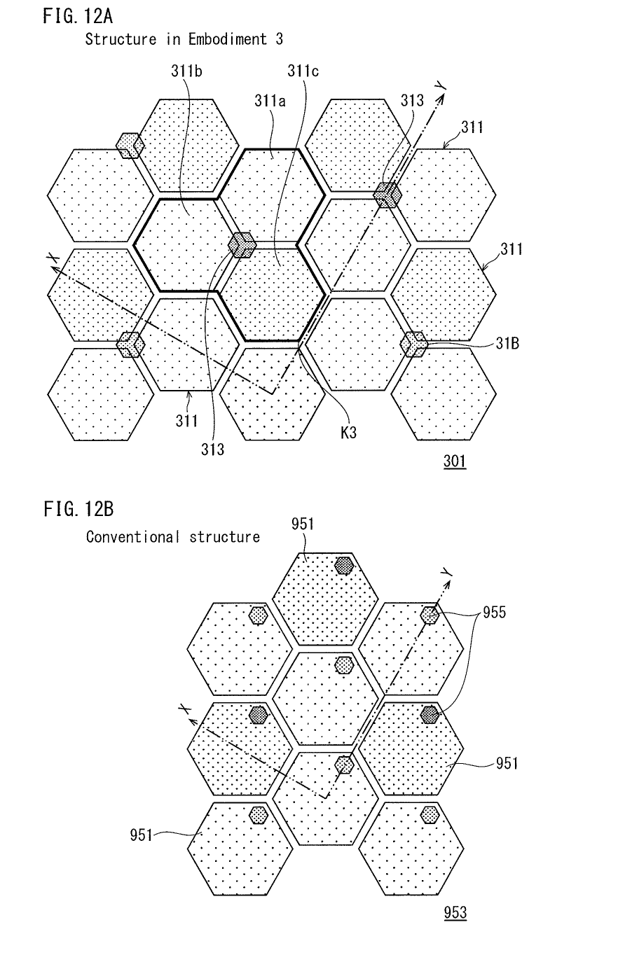

FIG. 12A and FIG. 12B are schematic plan views respectively showing a display panel relating to Embodiment 3 and a display panel having a conventional structure that each include subpixels each having a hexagonal shape in plan view.

As shown in FIG. 12A, the display panel 301 includes a plurality of subpixels 311, which are each a hexagon in plan view, indirectly on a TFT substrate (not illustrated) with an insulating film (not illustrated) between the subpixels 311 and the TFT substrate.

The subpixels 311, which are each a hexagon shown in FIG. 12A, are arranged in the X direction and the Y direction that respectively correspond to a first direction and a second direction of the present invention. Each two or more of the subpixels 311, which are arranged in the X direction, form an array such that one of six sides of the hexagonal shape of each of the subpixels 311 faces one of six sides of the hexagonal shape of adjacent of the subpixels 311. With respect to each of the arrays of the subpixels 311 in the X direction, an array of the subpixels 311 in the Y direction is located offset by half pitch of the subpixel 311 so as to be adjacent to each other.

In Embodiment 3, each subpixel set is composed of three subpixels 311a, 311b, and 311c, and one contact window 313 is formed in a region including the subpixel set. In FIG. 12A, a perimeter that surrounds each region including one subpixel set is represented by a line segment K3.

Specifically, the contact window 313 is formed in a position where one of apex angles of each of the three subpixel 311a, 311b, and 311c is positioned, so as to extend over the three subpixel 311a, 311b, and 311c.

FIG. 12B shows a display panel 953 having a conventional structure in which a plurality of subpixels 951 that are each a hexagon in plan view are arranged in the X direction and the Y direction.

The display panel 953 having the conventional structure has one contact window 955 for each subpixel 951 that is a hexagon in plan view similar to in Embodiment 3.

According to the display panel 301 relating to Embodiment 3 compared with this, three subpixels (subpixels 311a, 311b, and 311c for example) share one contact window 313. Only with ⅓ of the circumferential surface of the contact window 313, an anode and a TFT element are connected with each other. This increases the aperture ratio compared with the display panel 953 having the conventional structure in which one TFT element is provided for each contact window 955.

In Embodiment 3, three subpixels 311a, 311b, and 311c constitute one subpixel set. Alternatively, two adjacent subpixels (subpixels 311a and 311b, for example) may constitute one subpixel set.

### Summary

The display panels described in the above embodiments and so on are examples of the present invention. That is, the present invention is not limited by the number of subpixels, the shape of the subpixels, the number of contact windows, the shape of the contact windows, and so on, and is applicable to display panels of various types of specifications.

The following describes the display panels of various types of specifications. Description is given here on a display panel including subpixels that are rectangular in plan view. Furthermore, there is a case where the following description is also applicable to a display panel having subpixels that are hexagonal in plan view such as described in Embodiment 3, a display panel having subpixels having other shapes in plan view, and the like.

### 1. Example 1

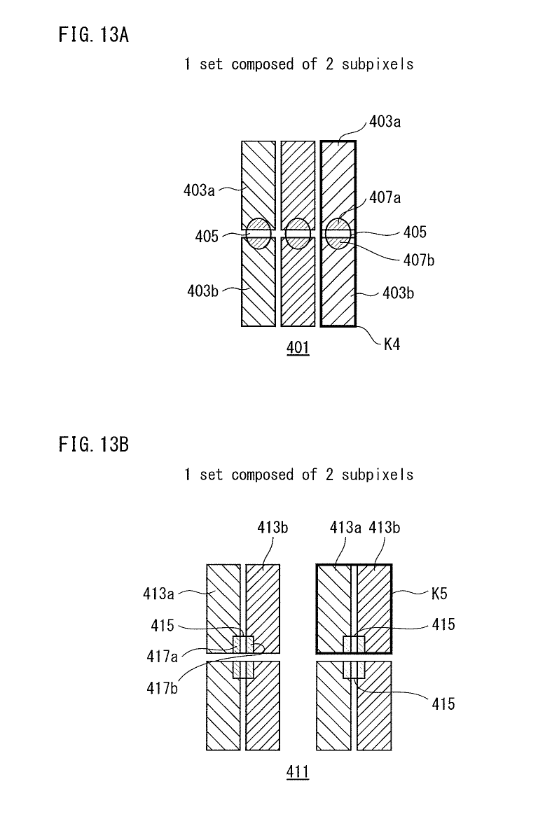

FIG. 13A and FIG. 13B are each a schematic plan view showing a display panel including subpixel sets that are each composed of two subpixels.

FIG. 13A shows a display panel 401 in which each subpixel set is composed of two adjacent subpixels 403a and 403b, and one contact window 405 is located in a region including each subpixel set (in FIG. 13A, a perimeter that surrounds each region including one subpixel set is represented by a line segment K4). Note that an anode (strictly, connecting part) is connected with a TFT element in each of hatched parts 407a and 407b with diagonal lines running upwardly from left to right.

The two subpixels 403a and 403b, which are rectangular, are adjacent to each other in a longitudinal direction thereof (the vertical direction in Embodiment 1).

The contact window 405 shown in FIG. 13A is an ellipse or a rounded rectangle that is elongated in the longitudinal direction of the rectangular subpixels 403a and 403b. Alternatively, the contact window may be a rectangle that is elongated in the longitudinal direction, or a rectangle, an ellipse, a rounded rectangle, or the like that is short in the longitudinal direction. The shape of the contact window 405 in plan view is not particularly limited.

FIG. 13B shows a display panel 411 in which each subpixel set is composed of two adjacent subpixels 413a and 413b, and one contact window 415 is located in a region including the subpixel set (in FIG. 13B, a perimeter that surrounds each region including one subpixel set is represented by a line segment K5). Note that an anode (strictly, connecting part) is connected with a TFT element in each of hatched parts 417a and 417b with diagonal lines running upwardly from left to right.

The two subpixels 413a and 413b, which are rectangular, are adjacent to each other in a short direction thereof (the horizontal direction in Embodiment 1) that is a direction parallel to the short side of the subpixels.

The contact window 415 shown in FIG. 13B is a rectangle that is elongated in the short direction of the rectangular subpixels 413a and 413b. Alternatively, the contact window may be a rounded rectangle, an ellipse, or the like that is elongated in the short direction, or a rectangle, a rounded rectangle, an ellipse, or the like that is elongated in the longitudinal direction. The shape of the contact window in plan view is not particularly limited.

### 2. Example 2

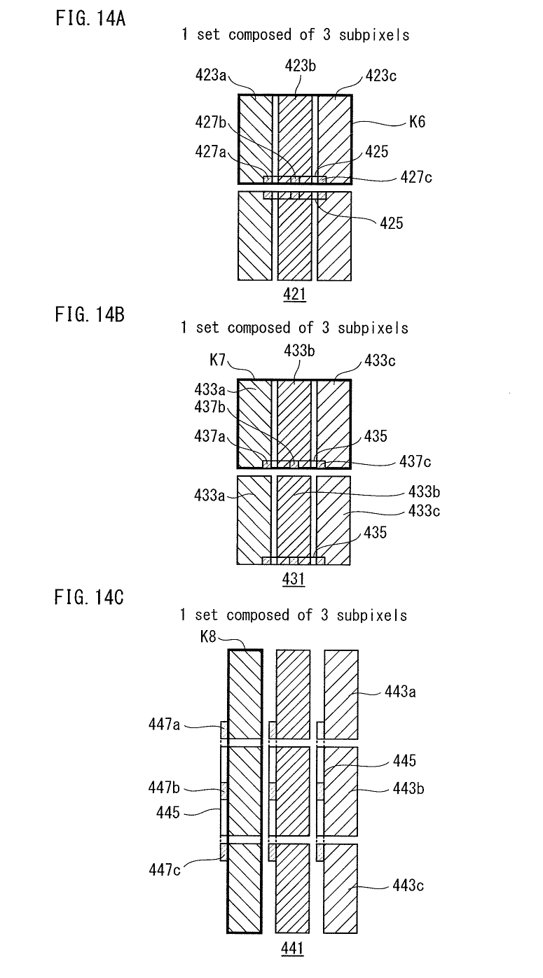

FIG. 14A to FIG. 14C are each a schematic plan view showing a display panel including subpixel sets that are each composed of three subpixels.

FIG. 14A shows a display panel 421 in which each subpixel set is composed of three adjacent subpixels 423a, 423b, and 423c, and one contact window 425 is located in a region including the subpixel set (in FIG. 14A, a perimeter that surrounds each region including one subpixel set is represented by a line segment K6). Note that an anode (strictly, connecting part) is connected with a TFT element in each of hatched parts 427a, 427b, and 427c with diagonal lines running upwardly from left to right.

The three subpixels 423a, 423b, and 423c, that are rectangular, are adjacent to each other in a short direction thereof.

The contact window 425 shown in FIG. 14A is a rectangle that is elongated in the short direction of the rectangular subpixels 423a, 423b, and 423c, which is equal to the adjacent direction of the subpixels. Alternatively, the contact window may be a rounded rectangle, an ellipse, or the like that is elongated in the short direction. The shape of the contact window in plan view is not particularly limited.

The contact window 425 is formed in each subpixel set on the side of a vertically adjacent subpixel set that faces the subpixel set. In other words, one subpixel set composed of three subpixels 423a, 423b, and 423c (subpixel set on the upper side in the vertical direction) is paired with another subpixel set composed of three subpixels 423a, 423b, and 423c (subpixel set on the lower side in the vertical direction) which is adjacent to the one subpixel set in a direction perpendicular to the adjacent direction of the three subpixels 423a, 423b, and 423c. The contact window 425 is formed in each of the one subpixel set on the side close to the other subpixel set, and the other subpixel set on the side close to the one subpixel set.

FIG. 14B shows a display panel 431 in which each subpixel set is composed of three adjacent subpixels 433a, 433b, and 433c, and one contact window 435 is located in a region including the subpixel set (in FIG. 14B, a perimeter that surrounds each region including one subpixel set is represented by a line segment K7). Note that an anode (strictly, connecting part) is connected with a TFT element in each of hatched parts 437a, 437b, and 437c with diagonal lines running upwardly from left to right.

The display panel 431 is equal to the display panel 421 shown in FIG. 14A in terms of adjacent directions of three subpixels constituting each subpixel set and shape of contact window. The display panel 431 has a different structure from the display panel 421 in which each contact window 435 is located on the lower side of the subpixel set in the vertical direction. In other words, the display panel 431 has the different structure from the display panel 421 in which each contact window 435 is located in one subpixel set on the side close to another subpixel set which is adjacent to the one subpixel set in a direction perpendicular to the adjacent direction of the three subpixels 423a, 423b, and 423c (horizontal direction), namely, a subpixel set on the lower side in the vertical direction.

That is, while the contact window 425 shown in FIG. 14A is formed in each subpixel set on the side of a vertically adjacent subpixel set that faces the subpixel set (between each two adjacent subpixel sets in FIG. 14A), the contact window 435 shown in FIG. 14B is formed in a predetermined position in a region including each subpixel set (position on the lower side of the subpixel set).

FIG. 14C shows a display panel 441 in which each subpixel set is composed of three adjacent subpixels 443a, 443b, and 443c, and one contact window 445 is located outside a region including the subpixel set (in FIG. 14C, a perimeter that surrounds each region including one subpixel set is represented by a line segment K8). Note that an anode (strictly, connecting part) is connected with a TFT element in each of hatched parts 447a, 447b, and 447c with diagonal lines running upwardly from left to right.

The three subpixels 443a, 443b, and 443c, which are rectangular, are adjacent to each other in a longitudinal direction thereof.

The contact window 445 shown in FIG. 14C is a rectangle that is elongated in the longitudinal direction of the rectangular subpixels 443a, 443b, and 443c. Alternatively, the contact window may be an ellipse, a rounded rectangle, or the like that is elongated in the longitudinal direction. The shape of the contact window in plan view is not particularly limited.

The contact window 445 is formed between a region including one subpixel set composed of three subpixels 443a, 443b, and 443c (subpixel set shown in the right side in FIG. 14C, for example) and a region including another subpixel set (subpixel set shown in the center in FIG. 14C, for example) that is adjacent to the one subpixel set in a direction perpendicular to the adjacent direction of the three subpixels 443a, 443b, and 443c (vertical direction).

Note that anodes corresponding one-to-one to the subpixels 443a and 443c which constitute each subpixel set and are respectively located on the end sides in the adjacent direction each have, between an electrode part formed on an insulating film and a coupling part formed on a circumferential surface of the contact window 445, an extending part formed on the insulating film that extends from the electrode part to the coupling part. The extending part is indicated by dashed lines in FIG. 14C.

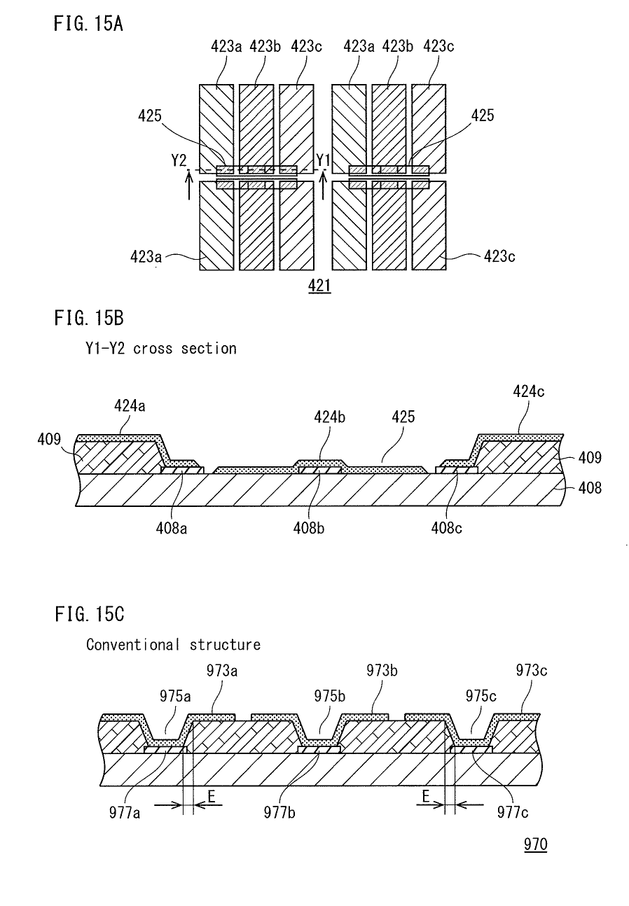

FIG. 15A to FIG. 15C describe the aperture ratio of the display panel shown in FIG. 14A, where FIG. 15A is a plan view showing the display panel, FIG. 15B shows a Y1-Y2 cross section of the display panel in FIG. 15A viewed in an arrow direction, and FIG. 15C shows a cross section of a display panel having a conventional structure that corresponds to the Y1-Y2 cross section in FIG. 20.

A display panel 421 has one contact window 425 for three subpixels 423a, 423b, and 423c that are horizontally adjacent to each other. As shown in FIG. 15B, anodes 424a and 424c, which respectively correspond to the subpixels 423a and 423c, which are positioned on the end sides of the subpixels 423a, 423b, and 423c in the adjacent direction, are respectively connected with TFT elements 408a and 408c of a substrate 408 on the side close to the subpixel 423b that is positioned on the center among the three subpixels 423a, 423b, and 423c.

Compared with this, a display panel 970 having a conventional structure has three contact windows 975a, 975b, and 975c for each of three subpixels that are horizontally adjacent to each other. Anodes 973a, 973b, and 973c are respectively connected with TFT elements 977a, 977b, and 977c.

Accordingly, compared with the display panel 970 having the conventional structure, the display panel 421 does not need to provide, on the cross section, the length of one of circumferential surfaces of the contact window (taper length) of each of the subpixels 423a and 423c, which are positioned on the end sides of the three adjacent subpixels. In other words, the display panel 421 has a reduced length in the adjacent direction by the length 2E for each three subpixels shown in FIG. 15C compared with the display panel 970, thereby increasing the aperture ratio.

### 3. Example 3

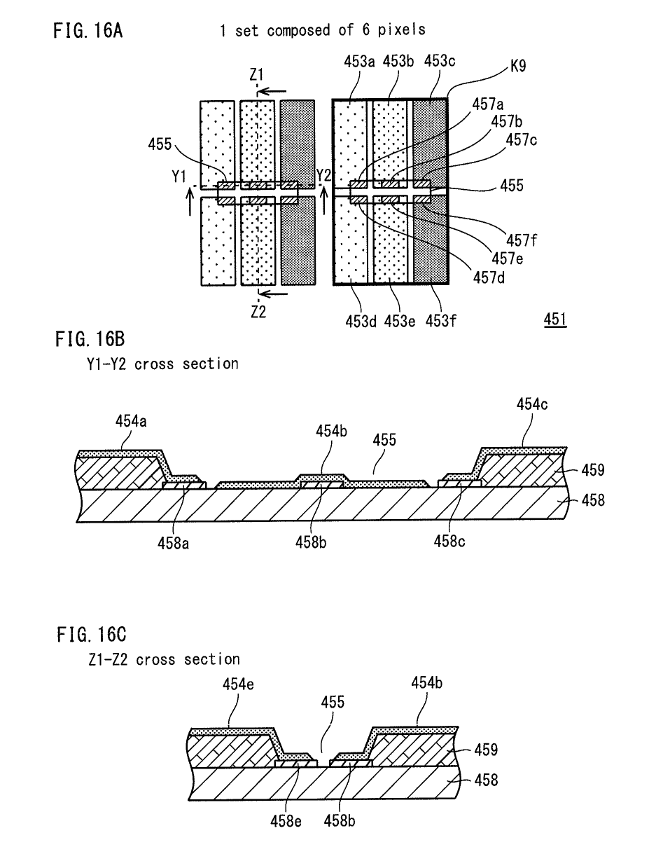

FIG. 16A is a schematic plan view showing a display panel including subpixel sets that are each composed of six subpixels, FIG. 16B shows a Y1-Y2 cross section of the display panel in FIG. 16A viewed in an arrow direction, and FIG. 16C shows a Z1-Z2 cross section of the display panel in FIG. 16A viewed in an arrow direction.

FIG. 16A shows a display panel 451 in which each subpixel set is composed of six adjacent subpixels 453a to 453f, and one contact window 455 is located in a region including the subpixel set (in FIG. 16A, a perimeter that surrounds each region including one subpixel set is represented by a line segment K9). Note that an anode (strictly, connecting part) is connected with a TFT element in each of parts 457a to 457f represented by right diagonal hatched parts.

The six subpixels 453a to 453f, which are rectangular, and adjacent to each other in a short direction thereof (horizontal direction) and a longitudinal direction thereof (vertical direction). Note that the short direction and the longitudinal direction respectively correspond to the first direction and the second direction of the present invention, and are perpendicular to each other.

The contact window 455 shown in FIG. 16A is a rectangle that is elongated in the short direction of the rectangular subpixels 453a, 453b, and 453c. Alternatively, the contact window may be an ellipse, a rounded rectangle, or the like that is elongated in the short direction. The shape of the contact window in plan view is not particularly limited.

The contact window 455 is formed in a position where three subpixels 453a, 453b, and 453c which are adjacent to each other in the short direction faces, in the longitudinal direction, another three subpixels 453d, 453e, and 453f which are adjacent to each other in the short direction. In other words, the contact window 455 is formed between each two subpixels which are adjacent to each other in the longitudinal direction so as to stride over the six subpixels 453a to 453f.

As shown in FIG. 16B, anodes 454a and 454c (anodes 454d and 454f) respectively corresponding to the subpixels 453a and 453c (subpixels 453d and 453f), which are positioned on the end sides of the subpixels 453a, 453b, and 453c (subpixels 453d, 453e, and 453f) in the adjacent direction, are respectively connected with TFT elements 458a and 458c (TFT elements 458d and 458f) of a substrate 458 on the side close to the subpixel 453b (subpixel 435e) that is positioned on the center among the subpixels 453a, 453b, and 453c (subpixels 453d, 453e, and 453f).

As described above, on the cross section of each three adjacent subpixels which are adjacent to each other in the short direction, the subpixels 453a and 453c, which are positioned on the end sides among the subpixels 453a, 453b, and 453c that are adjacent to each other in the short direction, are respectively connected with the TFT elements 458a and 458c with use of the circumferential surface of the contact window 455. This reduces influences of the contact window 455, thereby increasing the aperture ratio.

Also, as shown in FIG. 16C, each two subpixels 453b and 453e (subpixels 453a and 453d, and subpixels 453c and 453f), which are adjacent to each other in the longitudinal direction, are respectively connected with TFT elements 458b and 458e (TFT elements 458a and 458d, and TFT elements 458c and 458f) provided on a substrate 458 in one contact window 455.

As described above, on the cross section of each two adjacent subpixels which are adjacent to each other in the longitudinal direction, the two subpixels 453b and 453e (subpixels 453a and 453d, and subpixels 453c and 453f) are respectively connected with the TFT elements 458b and 458e (TFT elements 458a and 458d, and TFT elements 458c and 458f), with use of the end sides of the circumferential surface of the contact window 455. Accordingly, the circumferential surface of the contact window 455 is effectively used, thereby increasing the aperture ratio.

### 4. Example 4

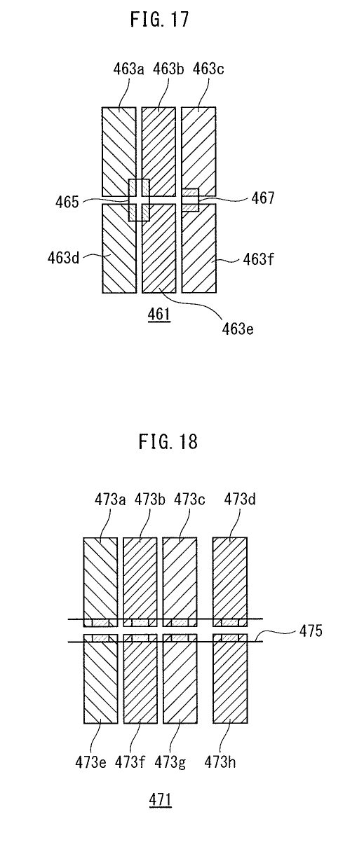

FIG. 17 is a schematic plan view showing a display panel in which a subpixel set composed of four subpixels are combined with a subpixel set composed of two subpixels.

A display panel 461 has a first subpixel set composed of four adjacent subpixels 463a, 463b, 463d, 463e, a second subpixel set composed of two adjacent subpixels 463c and 463f, and a contact window 465 located in a region including the first subpixel set and a contact window 467 is located in a region including the second subpixel set.

Note that an anode (strictly, connecting part) is connected with a TFT element in each of hatched parts with diagonal lines running upwardly from left to right.

The description given here is for explaining the structure in which two or more subpixel sets, which are each composed of different number of subpixels, are combined with each other. The display panel 461 shown in FIG. 17 is just an example. Accordingly, the number of subpixels constituting each subpixel set, the position and the shape of contact window are not limited to those shown in FIG. 17.

For example, combination of subpixel sets may be formed from a subpixel set composed of three subpixels 423a, 423b, and 423c such as shown in FIG. 14A and a subpixel set composed of six subpixels 453a to 453f such as shown in FIG. 16A. Alternatively, combination of subpixel sets may be formed from a subpixel set composed of four subpixels 463a, 463b, 463d, and 463e such as shown in FIG. 17, a subpixel set composed of two subpixels 463c and 463f such as shown in FIG. 17, and a subpixel set composed of six subpixels 453a to 453f such as shown in FIG. 16A.

### 5. Example 5

FIG. 18 is a schematic plan view showing a display panel having openings that each have a groove shape.

A display panel 471 has a groove 475 as an opening that is formed between adjacent two subpixels in a longitudinal direction of the subpixels (subpixels 473a and 473e, subpixels 473b and 473f, subpixels 473c and 473g, and subpixels 473d and 473h) so as to extend in a short direction of the subpixels.

The grooves 475 extending in the short direction here are formed as openings in the display panel 471. Alternatively, a groove is applicable to display panels having other structures. For example, the display panel 441 shown in FIG. 14C may have grooves extending in the longitudinal direction of the subpixels 443, instead of the contact windows 445. Further alternatively, a display panel may have grooves in combination with the contact windows described in Embodiment 1 and so on.

### 6. Example 6

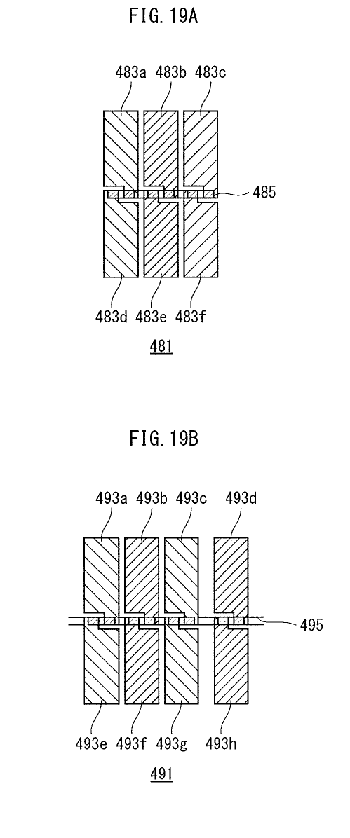

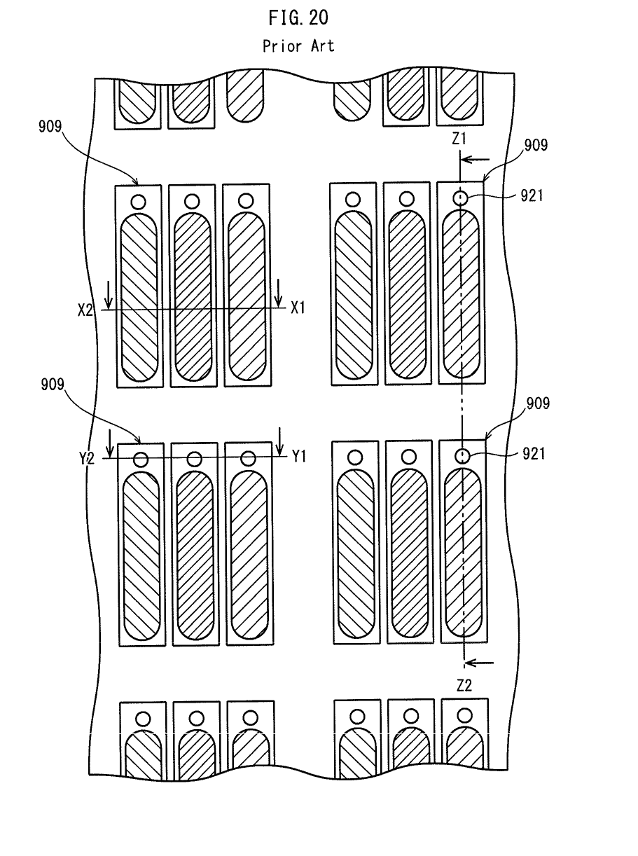

FIG. 19A and FIG. 19B are each a schematic view showing a display panel in which anodes corresponding one-to-one to two vertically adjacent subpixels, which are an upper subpixel and a lower subpixel, are each connected with a TFT element in an opening such that the anodes corresponding to the upper subpixels and the anodes corresponding to the lower supixels are alternated with each other in the horizontal direction.

In Embodiment 2, the contact window 223, which is formed for the two subpixels 211a and 211b that are adjacent to each other in the longitudinal direction thereof, is divided into two regions. The anodes 207a and 207b, which respectively correspond to the subpixels 211a and 211b, mutually extend toward each other in the longitudinal direction so as to be connected with the TFT elements 221a and 221b respectively.

FIG. 19A shows a display panel 481 in which six subpixels 483a to 483f are adjacent to each other in a longitudinal direction and a short direction thereof, and a contact window 485 that is elongated in the short direction in plan view is formed so as to correspond to each subpixel set composed of the six subpixels 483a to 483f.

The subpixels 483a to 483f are each connected with a TFT element such that respective anodes included in each two subpixels (subpixel on one side and subpixel on the other side) that are adjacent to each other in the longitudinal direction extend toward each other. Anodes included in the subpixels on the one side and anodes included in the subpixels on the other side are alternately arranged in the short direction inside the contact window 485.

Specific description is given with reference to FIG. 19A. Respective anodes included in subpixels on one side (subpixels 483a to 483c on the upper side) in the longitudinal direction each extend toward a corresponding one of subpixels on the other side (subpixels 483d to 483f on the lower side) in the longitudinal direction. Similarly, respective anodes included in subpixels on the other side in the longitudinal direction (subpixels 483d to 483f on the lower side) each extend toward a corresponding one of the subpixels on the one side in the longitudinal direction (subpixels 483a to 483c on the lower side).

As described above, respective anodes, which are included in each two subpixels that are adjacent to each other in the longitudinal direction, extend toward each other. The width of an extending portion of each of the anodes (the length of the extending portion in the short direction) is equal to or less than half the width of the anode included in the subpixel. The total width of the respective extending portions of the two anodes included in the two adjacent subpixels is equal to or less than the width of the subpixel.

FIG. 19B shows a display panel 491 in which each subpixel set is composed of six subpixels 493a to 493f that are adjacent to each other in a longitudinal direction and a short direction thereof, and a groove 495 is formed between adjacent two subpixels in the longitudinal directions (subpixels 493a and 493e and subpixels 493b and 493f) so as to extend in the short direction.

The subpixels 493a to 493f are each connected with a TFT element such that respective anodes included in each two subpixels that are adjacent to each other in the longitudinal direction (pixel on one side and pixel on the other side) extend toward each other, such that the subpixels on the one side and the subpixels on the other side are alternately arranged inside the groove 495 in the short direction.

### Modifications

Although the description has been given on the above embodiments and so on, the present invention is not limited to the above embodiments and so on. The present invention for example includes the following modifications.

### 1. Structure of Light Emitting Element

In the above embodiments and so on, the light emitting elements each include, as the basic structure, a pixel electrode (anode), a light emitting layer, and a common electrode (cathode). Alternatively, the light emitting element may further include an auxiliary functional layer above these layers (also collectively referred to just as functional layer) in order to improve the functions of the functional layer.

The auxiliary functional layer for example includes a hole injection layer, a electron injection layer, a passivation layer, and so on. The hole injection layer promotes injection of holes from the pixel electrode to the light emitting layer. The electron injection layer promotes injection of electrons from the common electrode to the light emitting layer. The passivation layer suppresses deterioration of the light emitting layer due to exposure to moisture, air, and so on.

### 2. Shape of Light Emitting Element

In the above Embodiments 1 and 2 and Examples 1 to 6, the light emitting element has a rectangle shape that is elongated in the vertical direction of the display panel. Alternatively, the light emitting element may have a rectangle shape that is elongated in the horizontal direction of the display panel.

### 3. Display Element

In the above embodiments and so on, the description has been given on the display panel using light emitting elements as display elements. Alternatively, the present invention is applicable to a display panel that display images by feeding an electric power individually to each of a plurality of display elements that are two-dimensionally arranged. In addition to the light emitting elements described in the above embodiments and so on, display elements for use in TFT-driven liquid crystal panels may be used.

### 4. Substrate

In the above embodiments and so on, a TFT substrate is used as the substrate for the display panel. Alternatively, TFT elements do not necessarily need to be used as long as an electric power is fed individually to each of display elements formed on the substrate. For example, an insulating plate on which TFDs (thin film diodes) are formed may be used as the substrate.

Also, in the above embodiments and so on, the description has been given that a TFT substrate on which TFT elements are formed is used as the substrate for the display panel, and display elements are connected with TFT elements in one-to-one correspondence. This means that a pixel electrode corresponding to each display element is connected with a marginal TFT element. Alternatively, a substrate may be used which has formed thereon a plurality of TFT elements including the marginal TFT element for feeding an electric power to pixel electrodes.

### 5. Light Extraction Structure

In the above embodiments and so on, a display panel of a so-called top emission type is used which has a light extraction direction opposite to the substrate. Alternatively, a display panel of a so-called bottom emission type may be used which has a light extraction direction toward the substrate.

In this case, a transparent substrate such as a glass substrate is used as a substrate, a transparent electrode such as ITO is used as a pixel electrode on the side of light extraction (side close to the substrate), and a high-reflective electrode such as Ag and Al is used as an electrode on the opposite side of light extraction (side far from the substrate).

### 6. Others

Although the above description has been given on an EL display panel as an example, the present invention is also applicable to liquid crystal display panels and EL display panels including organic TFTs as drive circuit elements, and of course exhibits the same effects.

### INDUSTRIAL APPLICABILITY

The display panel relating to the present invention is preferably utilizable as display panels for use in various types of displays for households, public facilities, and business, and so on, displays for television devices, portable electronic devices, and so on.

### REFERENCE SIGNS LIST

10 display panel

101 TFT substrate

103 insulating film

107 anode

109 light emitting layer

111 anode

113 bank

123 contact window

1. A display panel that displays images by feeding an electric power individually to each of a plurality of display elements that are two-dimensionally arranged, wherein
the plurality of display elements are provided indirectly on a surface of a substrate with an insulating film between the plurality of display elements and the substrate,
the insulating film has one opening in a part thereof corresponding to each at least two of the plurality of display elements that are adjacent to each other, and feed terminals corresponding one-to-one to the at least two display elements are provided on a part of the substrate that is exposed inside the opening so as to share the opening.

2. The display panel of claim 1, wherein
the opening is provided in plural,
the plurality of openings are dispersed over the insulating film, and
the plurality of display elements each share one of the plurality of openings with at least another one of the plurality of display elements.

3. The display panel of claim 1, wherein
when viewed in plan, the part of the insulating film corresponding to the at least two display elements is positioned inside a region surrounded by a perimeter of the at least two display elements.

4. The display panel of claim 1, wherein
the plurality of display elements are arranged in a first direction and a second direction that intersects the first direction, and
the feed terminals are provided in at least one of the first direction and the second direction.

5. The display panel of claim 1, wherein
when viewed in plan, the part of the insulating film corresponding to the at least two display elements is positioned outside a region surrounded by a perimeter of the at least two display elements.

6. The display panel of claim 1, wherein
the openings each have one of a pore shape and a groove shape.

7. The display panel of claim 1, wherein
the plurality of display elements each include a pixel electrode having an electrode part provided on the insulating film, a coupling part extending from the electrode part into the opening shared by the display element, and a connecting part provided in the opening,
pixel electrodes included in each adjacent two of the plurality of display elements are provided in a first direction,
two feed terminals corresponding one-to-one to the two display elements are provided in a second direction perpendicular to the first direction, and
the two pixel electrodes included in the adjacent two display elements extend toward each other to reach inside the opening shared by the two display elements, such that respective connecting parts of the two pixel electrodes are connected with the two feed terminals.

8. The display panel claim 1, wherein
the plurality of display elements each include a pixel electrode having an electrode part provided on the insulating film, a coupling part extending from the electrode part into the opening shared by the display element, and a connecting part provided in the opening, and
a bank is provided on the insulating film so as to have a plurality of apertures corresponding one-to-one to the plurality of pixel electrodes at equal intervals.

9. A method for manufacturing a display panel that displays images by feeding an electric power individually to each of a plurality of display elements that are two-dimensionally arranged, the method comprising:
preparing a substrate including thereon a plurality of feed terminals corresponding one-to-one to the plurality of display elements;
forming, on the substrate, an insulating film having one opening in a part thereof corresponding to each at least two of the plurality of feed terminals that are adjacent to each other; and
forming, on the insulating film, at least two display elements that are to be connected one-to-one with the at least two feed terminals so as to be close to the opening.

10. The display panel of claim 2, wherein
the plurality of display elements each include a pixel electrode having an electrode part provided on the insulating film, a coupling part extending from the electrode part into the opening shared by the display element, and a connecting part provided in the opening, and
a bank is provided on the insulating film so as to have a plurality of apertures corresponding one-to-one to the plurality of pixel electrodes at equal intervals.

11. The display panel of claim 3, wherein
the plurality of display elements each include a pixel electrode having an electrode part provided on the insulating film, a coupling part extending from the electrode part into the opening shared by the display element, and a connecting part provided in the opening, and
a bank is provided on the insulating film so as to have a plurality of apertures corresponding one-to-one to the plurality of pixel electrodes at equal intervals.

12. The display panel of claim 4, wherein
the plurality of display elements each include a pixel electrode having an electrode part provided on the insulating film, a coupling part extending from the electrode part into the opening shared by the display element, and a connecting part provided in the opening, and
a bank is provided on the insulating film so as to have a plurality of apertures corresponding one-to-one to the plurality of pixel electrodes at equal intervals.

13. The display panel of claim 5, wherein
the plurality of display elements each include a pixel electrode having an electrode part provided on the insulating film, a coupling part extending from the electrode part into the opening shared by the display element, and a connecting part provided in the opening, and
a bank is provided on the insulating film so as to have a plurality of apertures corresponding one-to-one to the plurality of pixel electrodes at equal intervals.

14. The display panel of claim 6, wherein
the plurality of display elements each include a pixel electrode having an electrode part provided on the insulating film, a coupling part extending from the electrode part into the opening shared by the display element, and a connecting part provided in the opening, and
a bank is provided on the insulating film so as to have a plurality of apertures corresponding one-to-one to the plurality of pixel electrodes at equal intervals.
